(19) United States
(12) Patent Application Publication
(10) Pub. No.: US 2016/0339672 A1
(43) Pub. Date: Nov. 24, 2016

(54) DOUBLE-SIDED ADHESIVE TAPE AND ELECTRONIC DEVICE

(71) Applicant: DIC CORPORATION, Tokyo (JP)

(72) Inventors: Yumi Kagiyama, Kita-adachi-gun (JP); Hideaki Takei, Kita-adachi-gun (JP); Akira Yamakami, Kita-adachi-gun (JP); Takeshi Iwasaki, Kita-adachi-gun (JP)

(73) Assignee: DIC Corporation, Tokyo (JP)

(21) Appl. No.: 15/108,130

(22) PCT Filed: Dec. 9, 2014
(86) PCT No.: PCT/JP2014/082507

§ 371 Date: Jun. 24, 2016

(30) Foreign Application Priority Data
Dec. 25, 2013 (JP) 2013-267014

(51) Int. Cl. B32B 5/24; C09J 175/04; C09J 7/02; B32B 7/12; B32B 27/36

(52) U.S. Cl. CPC B32B 5/245; B32B 7/12; B32B 27/36; C09J 7/0296; C09J 7/0285; C09J 7/0246; C09J 175/04; B32B 2307/54; B32B 2307/558; B32B 2405/00; B32B 2457/00; C09J 2201/128; C09J 2201/162; C09J 2467/006; C09J 2203/326

(57) ABSTRACT

There is provided a double-sided pressure-sensitive adhesive tape including resin films laminated on both surfaces of a foaming body substrate, and pressure-sensitive adhesive layers laminated on the surface of the resin film, in which the foaming body substrate has a density of 0.45 g/cm³ or less, and an interlaminar strength of 10 N/cm or more, and pressure-sensitive adhesive layer exhibits a 180° peeling adhesive force of 10 N/20 mm or more when a pressure-sensitive adhesive tape obtained by providing the pressure-sensitive adhesive layer on a polyethylene terephthalate substrate having a thickness of 25 μm such that the thickness of the pressure-sensitive adhesive layer is 25 μm is allowed to adhere onto an aluminum plate with pressure under the predetermined environment, and is peeled at a peeling rate of 300 mm/min.

### TECHNICAL FIELD

The present invention relates to a double-sided pressure-sensitive adhesive tape which can be used to fix various components for constituting an electronic device and the like.

### BACKGROUND ART

A double-sided pressure-sensitive adhesive tape has been widely used in various cases, for example, for fixing components for constituting an electronic device. Specifically, the double-sided pressure-sensitive adhesive tape is used in manufacturing compact electronic devices such as a mobile phone, a camera, and a personal computer, namely, at the time of fixing rigid body components, for example, fixing a protective panel of an image display unit to a frame, and fixing exterior parts, batteries, and various member modules, to each other.

As a double-sided pressure-sensitive adhesive tape which can be preferably used to fix components for constituting a compact electronic device, for example, a double-sided pressure-sensitive adhesive tape which uses a flexible foaming body as a substrate has been known (for example, refer to PTLs 1 and 2).

On the other hand, as a compact electronic device is reduced in thickness and weight, it is likely to be portable, and accordingly, the possibility that the compact electronic device is accidently dropped has increased. In a case where the compact electronic device is dropped, the double-sided pressure-sensitive adhesive tape for constituting the compact electronic device may be peeled by the dropping impact, and thus a lack of components fixed by the double-sided pressure-sensitive adhesive tape may be caused.

Therefore, the double-sided pressure-sensitive adhesive tape has been required not only to be thin, but also to have impact resistance at a level of withstanding the dropping impact.

In addition, many expensive components, for example, a thin plate rigid body such as a protective panel and an image display module of an image display unit, and a thin-type battery have been used for a portable electronic device with high functionality. For this reason, an pressure-sensitive adhesive tape has been required to have disassembly properties at a level that can relatively easily and efficiently peel the components from the electronic device when a problem occurs in the electronic device.

Further, when the components are peeled from a main body such as the electronic device, pressure-sensitive adhesive of the double-sided pressure-sensitive adhesive tape remains on the components or the main body in some cases. The components on which the pressure-sensitive adhesive remains may cause a problem at the time of being reused. Thus, the double-sided pressure-sensitive adhesive tape has been required to have properties that can easily remove the pressure-sensitive adhesive which remains at the time of peeling the components.

### CITATION LIST

### Patent Literature

[PTL 1] JP-A-2010-155969
[PTL 2] JP-A-2010-260880

### SUMMARY OF INVENTION

### Technical Problem

An object of the present invention is to provide a double-sided pressure-sensitive adhesive tape which is thin but has preferable impact resistance, can be preferably disassembled when a certain force is applied, and can easily peel and remove residue such as an adhesive which remains on a surface of an adherend.

### Solution to Problem

According to the present invention, there is provided a double-sided pressure-sensitive adhesive tape including resin films laminated on both surfaces of a foaming body substrate, and pressure-sensitive adhesive layers laminated on the surface of the resin film, in which the foaming body substrate is a foaming body substrate having a density of 0.45 g/cm³ or less, and an interlaminar strength of 10 N/cm or more, and the pressure-sensitive adhesive layer exhibits a 180° peeling adhesive force of 10 N/20 mm or more, when a pressure-sensitive adhesive tape obtained by providing the pressure-sensitive adhesive layer on a polyethylene terephthalate substrate having a thickness of 25 μm such that the thickness of the pressure-sensitive adhesive layer is 25 μm is reciprocatively rolled once on an aluminum plate with a 2 kg roller under the environment of a temperature of 23° C. and a relative humidity of 65% RH, is left to stand for one hour under the environment of a temperature of 23° C. and a relative humidity of 50% RH, and is then peeled at a peeling rate of 300 mm/min. With this, the above-described problems can be solved.

### Advantageous Effects of Invention

According to the above-described configuration, the double-sided pressure-sensitive adhesive tape of the present invention is thin but has preferable impact resistance, and when a certain force is applied, a foaming body substrate generates interlayer crack and thus the double-sided pressure-sensitive adhesive tape can be preferably disassembled. In addition, it is possible to easily peel and remove a portion of the double-sided pressure-sensitive adhesive tape which remains on the surfaces of two or more disassembled adherends from the surface of the adherend.

Even in a case where a strong impact caused by dropping an electronic device is applied to the electronic device prepared by using the double-sided pressure-sensitive adhesive tape of the present invention, it is less likely that the components for constituting the electronic device will become peeled.

In addition, the double-sided pressure-sensitive adhesive tape of the present invention can be disassembled when a certain force is applied, and thus it is possible to prevent the fixed components from being cracked and distorted at the time of disassembling. Further, it is possible to efficiently disassemble a particular component from a defective product in the manufacturing of the electronic device or a recycled product of the electronic device. In addition, residue from the double-sided pressure-sensitive adhesive tape, which is remaining pressure-sensitive adhesive on the surface of the adherend can be also easily peeled and removed. The above-described double-sided pressure-sensitive adhesive tape of the present invention can be properly used to fix components for constituting a compact electronic device, and particularly used to fix thin plate rigid body components such as a protective panel or an image display module of an information display unit, and a thin-type battery of a compact electronic device.

### BRIEF DESCRIPTION OF DRAWINGS

FIG. 1 is a conceptual diagram viewed from a top surface of a test piece used in a test for impact resistance.

FIG. 2 is a conceptual diagram viewed from the top surface of the test piece used in the test for impact resistance.

FIG. 3 is a conceptual diagram of a testing method of an impact resistance test.

### DESCRIPTION OF EMBODIMENTS

A double-sided pressure-sensitive adhesive tape of the present invention includes resin films laminated on both surfaces of a foaming body substrate, and pressure-sensitive adhesive layers laminated on the surface of the resin film, in which the foaming body substrate is a foaming body substrate having a density of 0.45 g/cm³ or less and an interlaminar strength of 10 N/cm or more, and the pressure-sensitive adhesive layer exhibits a 180° peeling adhesive force of 10 N/20 mm or more when a pressure-sensitive adhesive tape obtained by providing the pressure-sensitive adhesive layer on a polyethylene terephthalate substrate having a thickness of 25 μm such that the thickness of the pressure-sensitive adhesive layer is 25 μm is rolled reciprocatively once on an aluminum plate with a 2 kg roller under the environment of a temperature of 23° C. and a relative humidity of 65% RH, is left to stand for one hour under the environment of a temperature of 23° C. and a relative humidity of 50% RH, and is then peeled at a peeling rate of 300 mm/min.

[Foaming Body Substrate]

As the foaming body substrate which is used in the present invention, the density thereof is 0.45 g/cm³ or less, is preferably in a range of 0.1 g/cm³ to 0.45 g/cm³, and further preferably in a range of 0.15 g/cm³ to 0.42 g/cm³. When the foaming body substrate having the density in the above-described range is used, it is possible to obtain a double-sided pressure-sensitive adhesive tape having preferable disassembly properties when a certain force is applied.

In addition, as the foaming body substrate used in the present invention, the interlaminar strength thereof is 10 N/cm or more, preferably in a range of 10 N/cm to 50 N/cm, and further preferably in a range of 10 N/cm to 25 N/cm. When the foaming body substrate in the above-described range is used, it is possible to realize both preferable disassembly properties and preferable impact resistance. In addition, when the foaming body substrate is used, it is possible to easily peel residue such as pressure-sensitive adhesive which remains on the surface of an adherend of the disassembled components.

The above-described interlaminar strength can be measured by using the following method. An pressure-sensitive adhesive layer having a thickness of 50 μm and strongly pressure-sensitive adhesive properties (it is not peeled from an adherend and a foaming body substrate when performing the following high-speed peeling test) is bonded on each of both surfaces of the foaming body substrate and then aging is performed at 40° C. for 48 hours so as to prepare a double-sided pressure-sensitive adhesive tape for measuring interlaminar strength. Next, a sample of the double-sided pressure-sensitive adhesive tape having a width of 1 cm and a length of 15 cm (in the flow direction and the width direction of the foaming body substrate) in which one side of the pressure-sensitive adhesive surface is backed with a polyester film having a thickness of 25 μm is rolled reciprocatively on a polyester film having a thickness of 50 μm, a width of 3 cm, and a length of 20 cm under the conditions of 23° C. and 50% RH with a 2 kg roller, and then is left to stand for 48 hours at 60° C. Thereafter, after the sample is further left to stand for 24 hours at 23° C., the side to which the polyester film having a thickness of 50 μm is bonded under the conditions of 23° C. and 50% RH is fixed to a mounting jig of a high-speed peeling tester, and then the polyester film having a thickness of 25 m is pulled in the 90° direction at a tension rate of 15 m/min so as to measure a maximum strength when the foaming body is torn.

As the foaming body substrate which is used in the present invention, 25% compressive strength is preferably 500 kPa or less, further preferably in a range of 10 kPa to 300 kPa, further preferably in a range of 10 kPa to 200 kPa, still further preferably in a range of 30 kPa to 180 kPa, and particularly preferably in a range of 50 kPa to 150 kPa. When the compressive strength is in the aforementioned range, it is possible to realize both preferable impact resistance and disassembly properties, and it is possible to obtain the double-sided pressure-sensitive adhesive tape having the preferable following properties with respect to the adherend.

Meanwhile, the 25% compressive strength can be measured based on JISK6767. Specifically, the sample of the double-sided pressure-sensitive adhesive tape which is cut into a 25 mm×25 mm square is laminated until the thickness became about 10 mm. A laminated body of the sample of the double-sided pressure-sensitive adhesive tape is sandwiched by a stainless steel plate having an area larger than that of the sample of the double-sided pressure-sensitive adhesive tape, and then the strength when the laminated body of the sample is compressed by about 2.5 mm (25% fraction of the original thickness) is measured at a speed of 10 mm/min at 23° C.

The tensile strength of the foaming body substrate used in the present invention in the flow direction and the width direction is not particularly limited, but is preferably in a range of 500 N/cm² to 1300 N/cm², and further preferably in a range of 600 N/cm² to 1200 N/cm². In addition, in the tensile test, the tensile elongation at the time of cutting is not particularly limited, but the tensile elongation in the flow direction is preferably in a range of 100% to 1200%, further preferably in a range of 100% to 1000%, and still further preferably in a range of 200% to 600%. When the foaming body substrate having the tensile strength and the tensile elongation which are in the aforementioned range is used, it is possible to suppress the deterioration of processability and bonding workability of the double-sided pressure-sensitive adhesive tape even with the foamed flexible substrate. In addition, it is possible to easily peel the double-sided pressure-sensitive adhesive tape after disassembly.

Meanwhile, the tensile strength of the above-described foaming body substrate in the flow direction and the width direction can be measured based on JISK6767. Specifically, the tensile strength is the maximum strength obtained by measuring the double-sided pressure-sensitive adhesive tape which is cut into the size of the marked line length of 2 cm and the width of 1 cm under the measurement condition of a tension rate of 300 mm/min in the environment of a temperature of 23° C. and a relative humidity of 50% RH by using a Tensilon tensile tester.

An average foam diameter of the foaming body substrate in the flow direction and the width direction is not particularly limited, but is preferably in a range of 10 μm to 500 μm, further preferably in a range of 30 μm to 400 μm, and still further preferably in a range of 50 μm to 300 μm. When the foaming body substrate having the average foam diameter in the flow direction and the width direction which is in the aforementioned range is used, it is possible to obtain the double-sided pressure-sensitive adhesive tape having further excellent pressure-sensitive adhesiveness with the adherend, and further excellent impact resistance.

Further, the ratio of the average foam diameter in the flow direction and the width direction (the average foam diameter in the flow direction/the average foam diameter in the width direction) is not particularly limited, but is preferably in a range of 0.2 to 4, further preferably in a range of 0.3 to 3, and still further preferably in a range of 0.4 to 1. When the ratio is in the aforementioned range, the variation of the flexibility or the tensile strength of the foaming body substrate in the flow direction and the width direction is less likely to occur.

The average foam diameter of the foaming body substrate used in the present invention in the thickness direction is preferably in a range of 3 μm to 100 μm, further preferably in a range of 5 μm to 80 μm, and still further preferably in a range of 5 μm to 50 μm. In addition, the average foam diameter in the aforementioned thickness direction is preferably equal to or less than ½ of the thickness of the foaming body substrate, and is preferably equal to or less than ⅓. When the ratio of the average foam diameter in the thickness direction to the thickness is preferably in the aforementioned range, it is easy to realize the disassembly properties and the impact resistance, and also realize excellent adhesiveness even when the rigid bodies are bonded to each other. In addition, the density and strength of the foaming body substrate are easily secured.

The ratio of the average foam diameter of the foaming body substrate in the flow direction with respect to the average foam diameter of the foaming body substrate in the thickness direction (the average foam diameter in the flow direction/the average foam diameter in the thickness direction), and the ratio of the average foam diameter of the foaming body substrate in the width direction with respect to the average foam diameter of the foaming body substrate in the thickness direction (the average foam diameter in the width direction/the average foam diameter in the thickness direction) are preferably 1 or more, further preferably 3 or more, and particularly preferably in a range of 4 to 25. When the ratios are in the aforementioned range, it is easy to secure the flexibility in the thickness direction and to realize excellent adhesiveness even when the rigid bodies are bonded to each other.

Meanwhile, the foaming body substrate in the width direction and the flow direction and the average foam diameter in the thickness direction are measured by using the following method.

First, the foaming body substrate is cut into the size of about 1 cm in the width direction and is cut into the size of about 1 cm in the flow direction such that ten test pieces are prepared.

Next, a certain range of the cutting surface of the above-described ten test pieces (the range of 1.5 mm in the flow direction and the entire length in the thickness direction) and (the range of 1.5 mm in the width direction and the entire length in the thickness direction) is imaged by using a digital microscope (product name “KH-7700” manufactured by HiROX Co., Ltd., magnification of 200).

Based on the captured image, bubble diameters of the entirety of bubbles (a diameter in the flow direction) existing in the aforementioned range of the ten test pieces (the range of 1.5 mm in the flow direction and the entire length in the thickness direction) are measured, and the average value thereof is set to be the average foam diameter in the flow direction.

Based on the captured image, the bubble diameter of the entirety of bubbles (a diameter in the width direction) existing in the aforementioned range of the ten test pieces (the range of 1.5 mm in the width direction and the entire length in the thickness direction) is measured, and the average value thereof is set to be the average foam diameter in the width direction.

Based on the captured image, the bubble diameter of the entirety of bubbles (a diameter in the thickness direction) existing in the aforementioned range of the ten test pieces (the range of 1.5 mm in the width direction and the entire length in the thickness direction) is measured, and the average value thereof is set to be the average foam diameter in the thickness direction.

When a bubble structure of the foaming body substrate used in the present invention is preferably set as an independent bubble structure, it is possible to effectively prevent flood or dust from the cutting surface of the foaming body substrate. When the shape of the bubble for forming the independent bubble structure is preferably set to be a rectangular shape in which the average foam diameter of the foaming body in the flow direction or the width direction, or both directions is longer than the average foam diameter of the foaming body in the thickness direction, the proper following properties and cushioning properties are obtained.

As the foaming body substrate used in the present invention, the thickness thereof is 250 μm or less, is preferably in a range of 50 μm to 250 μm, further preferably in a range of 80 μm to 200 μm, and still further preferably in a range of 100 μm to 150 μm. When the thickness is in the above-described range, it is easy to realize preferable impact resistance and the disassembly properties even in a case where the foaming body substrate is thin.

The compressive strength, the density, the interlaminar strength, the tensile strength, and the like of the foaming body substrate can be properly adjusted in accordance with materials of using substrates or bubble structures. The type of the foaming body substrate which is used in the present invention is not particularly limited as long as it is possible to realize the interlaminar strength and the like; however, a polyolefin-based foaming body and a polyurethane-based foaming body which are formed of polyethylene, polypropylene, an ethylene-propylene copolymer, an ethylene-vinyl acetate copolymer, or the like, and a rubber-based foaming body which is formed of acryl-based rubber, other elastomers, or the like can be used. Among them, the polyolefin-based foaming body can be preferably used from the aspect that the thin foaming body substrate of the independent bubble structure which is excellent in the following properties and impact absorbing properties with respect to unevenness of the surface of the adherend can be easily prepared.

Among the polyolefin-based foaming body which uses a polyolefin-based resin, when a polyethylene-based resin is preferably used, since a polyolefin-based foaming body having a uniform thickness can be easily prepared and flexibility is likely to be imparted thereto. Particularly, among the polyolefin-based resins, the content of the polyethylene-based resin is preferably 40% by mass or more, further preferably 50% by mass or more, still further preferably 60% by mass or more, and particularly preferably 100% by mass.

In addition, as the polyethylene-based resin used in the aforementioned polyolefin-based foaming body, a polyethylene-based resin obtained by using a metallocene compound containing a tetravalent transition metal as a polymerization catalyst is preferably used from the aspect that in a case where the polyethylene-based resin is a copolymer having a small molecular weight distribution, a copolymer component is introduced into any molecular weight component in approximately equal proportions, and thus it is possible to uniformly cross-link the polyolefin-based foaming body. For this reason, a foaming sheet is uniformly cross-linked and easily extended in a uniform manner as necessary, and thus it is easy to make the entire thickness of the obtained polyolefin-based resin foaming body uniform.

Further, as the polyolefin-based resin forming the polyolefin-based foaming body, other polyolefin-based resins may be contained in addition to the polyethylene-based resin which is obtained by using the metallocene compound containing the tetravalent transition metal as the polymerization catalyst. Examples of other polyolefin-based resins include a polyethylene-based resin except for the above-described polyethylene-based resin, and a polypropylene-based resin. In addition, the polyolefin-based resin may be used alone or two or more types thereof may be used in combination.

Examples of such a polyethylene-based resin include linear low-density polyethylene, low-density polyethylene, medium-density polyethylene, high-density polyethylene, an ethylene-α-olefin copolymer containing 50% by mass or more ethylene, and an ethylene-vinyl acetate copolymer containing 50% by mass or more ethylene, and these may be used alone or two or more types thereof may be used in combination. Examples of α-olefin forming the ethylene-α-olefin copolymer include propylene, 1-butene, 1-pentene, 4-methyl-1-pentene, 1-hexene, 1-heptene, and 1-octene.

In addition, the above-described polypropylene-based resin is not particularly limited, and for example, a propylene-α-olefin copolymer containing 50% by mass or more polypropylene and propylene is exemplified, and these may be used alone or two or more types thereof may be used in combination. Examples of α-olefin forming the propylene-α-olefin copolymer include ethylene, 1-butene, 1-pentene, 4-methyl-1-pentene, 1-hexene, 1-heptene, and 1-octene.

The polyolefin-based foaming body may be cross-linked. In the case where the polyolefin-based foaming body is prepared by causing a foamable polyolefin-based resin sheet to be foamed by using a thermal decomposition type foaming agent, it is preferable to use a polyolefin-based resin sheet which is cross-linked in advance. The degree of cross-linking is preferably in a range of 5% by mass to 60% by mass, and further preferably in a range of 10% by mass to 55% by mass such that the surface of the foaming sheet is prevented from being rough due to bubbles broken in the vicinity of surface of the foaming sheet at the time of extending the foaming body substrate, the deterioration of the adhesiveness of the pressure-sensitive adhesive layer is suppressed, and thus the double-sided pressure-sensitive adhesive tape which is excellent in the impact resistance and vibration properties is obtained.

Next, a method of preparing the polyolefin-based resin foaming body will be described. The method of preparing the polyolefin-based resin foaming body is not particularly limited; however, a method which includes a step of preparing a foaming polyolefin-based resin sheet in such a manner that a polyolefin-based resin containing 40% by mass or more polyethylene-based resin which is obtained by using the metallocene compound containing the tetravalent transition metal as the polymerization catalyst, a thermal decomposition type foaming agent, and a foaming auxiliary agent, and a foaming polyolefin-based resin composition containing a colorant for coloring a foaming body in black or white are supplied into an extruder and are melt-kneaded so as to be extruded in a sheet shape from the extruder; a step of cross-linking the foaming polyolefin-based resin sheet; a step of foaming the foaming polyolefin-based resin sheet; and a step of extending the foaming sheet by melting and softening the obtained foaming sheet so as to be extended in any one or both of the flow direction and the width direction, is exemplified. Note that, the step of extending the foaming sheet may be performed as necessary, and may be performed several times.

In addition, examples of the method of cross-linking a polyolefin-based resin foaming body substrate include a method of irradiating the foaming polyolefin-based resin sheet with ionizing radiation, and a method of mixing organic peroxide into the foaming polyolefin-based resin composition in advance, and then decomposing the organic peroxide by heating the obtained foaming polyolefin-based resin sheet, and these methods may be used in combination.

Examples of the ionizing radiation include an electron beam, an α ray, a β ray, and a γ ray. The dosage of ionizing radiation is properly adjusted such that a gel fraction of the polyolefin-based resin foaming body substrate is in the preferable range described above, but is preferably in a range of 5 kGy to 200 kGy. In addition, it is easy to obtain a uniform foaming state by applying the ionizing radiation, and thus it is preferable that both surfaces of the foaming polyolefin-based resin sheet are irradiated with the ionizing radiation, and it is further preferable that the dosage of ionizing radiation with which both surfaces of the foaming polyolefin-based resin sheet are irradiated is set to be the same.

Examples of the organic peroxide include 1,1-bis(t-butyl peroxy) 3,3,5-trimethyl cyclohexane, 1, 1-bis(t-butyl peroxy) cyclohexane, 2,2-bis(t-butyl peroxy) octane, n-butyl-4,4-bis(t-butyl peroxy) valerate, di-t-butyl peroxide, t-butyl cumyl peroxide, dicumyl peroxide, α,α′-bis(t-butylperoxy-m-isopropyl) benzene, 2,5-dimethyl-2,5-di(t-butyl peroxy) hexane, 2,5-dimethyl-2,5-di(t-butyl peroxy) hexyne-3, benzoyl peroxide, cumyl peroxy neodecanate, t-butyl peroxybenzoate, 2,5-dimethyl-2,5-di(benzoyl peroxy) hexane, t-butyl peroxy isopropyl carbonate, and t-butyl peroxy allyl carbonate, and these may be used alone or two or more types thereof may be used in combination.

The additive amount of the organic peroxide is preferably in a range of 0.01 parts by mass to 5 parts by mass, and further preferably in a range of 0.1 parts by mass to 3 parts by mass with respect to 100 parts by mass of polyolefin-based resin such that the foaming polyolefin-based resin sheet is sufficiently cross-linked, and decomposition residue of the organic peroxide is prevented from remaining in the obtained cross-linked polyolefin-based resin foaming sheet.

The additive amount of the thermal decomposition type foaming agent in the foaming polyolefin-based resin composition may be properly determined in accordance with the foaming magnification of the polyolefin-based resin foaming body substrate, but is preferably in a range of 1 part by mass to 40 parts by mass, and further preferably in a range of 1 part by mass to 30 parts by mass with respect to 100 parts by mass of polyolefin-based resin in order to impart a predetermined foaming magnification and obtain an excellent double-sided pressure-sensitive adhesive tape having excellent tensile strength and compression recovery.

In addition, the method of foaming the foaming polyolefin-based resin sheet is not particularly limited; however, examples thereof include a method of heating by using hot air, a method of heating by infrared rays, a method by salt bath, and a method by oil bath, and these methods may be used in combination. Among them, the method of heating by using hot air and the method of heating by infrared rays are preferably used from the aspect that a difference in appearance between the front and the back of the polyolefin-based resin foaming body substrate is small.

In addition, the extending of the foaming body substrate may be performed after the foaming polyolefin-based resin sheet is foamed and thus the foaming body substrate is obtained, or may be performed while foaming the foaming polyolefin-based resin sheet. Note that, in a case where the foaming body substrate is extended after the foaming polyolefin-based resin sheet is foamed and thus the foaming body substrate is obtained, the foaming body substrate may be continuously extended while being maintained in a melted state when the foaming is performed without cooling the foaming body substrate, or the foaming body substrate may be extended after the foaming body substrate is cooled and the foaming sheet is heated again so as to be in a melted or softened state.

Here, the melted state of the foaming body substrate means a state where the foaming body substrate is heated up to the temperature of both surfaces thereof which is equal to or higher than the melting point of the polyolefin-based resin for forming the foaming body substrate. In addition, the softening of the foaming body substrate means a state where the foaming body substrate is heated up to the temperature of both surfaces thereof which is equal to or higher than 20° C. and is lower than the melting point of the polyolefin-based resin for forming the foaming body substrate. When the foaming body substrate is extended, it is possible to prepare the polyolefin-based foaming body in which the aspect ratio of the bubbles is within a predetermined range by extending and deforming the bubbles of the foaming body substrate in a predetermined direction.

Further, regarding the direction in which the foaming body substrate is extended, the foaming body substrate is extended in the flow direction or the width direction, or the flow direction and the width direction of a rectangular foaming polyolefin-based resin sheet. Note that, in a case where the foaming body substrate is extended in the flow direction and the width direction, the foaming body substrate may be concurrently extended in the flow direction and the width direction, or may be separately extended in the flow direction or in the width direction.

Examples of the method of extending the foaming body substrate in the flow direction include a method of extending the foaming body substrate in the flow direction by increasing the speed (winding speed) at which the foamed rectangular foaming sheet is wound while being cooled as compared with the speed (supplying speed) at which the rectangular foaming polyolefin-based resin sheet is supplied to the foaming step, and a method of extending the foaming body substrate in the flow direction by increasing the speed (winding speed) at which the foaming body substrate is wound as compared with the speed (supplying speed) at which the foaming body substrate is supplied to the extending step.

Note that, in the former method, since the foaming polyolefin-based resin sheet is foamed by itself and thus is expanded in the flow direction, in a case where the foaming body substrate is extended in the flow direction, it is necessary to adjust the supplying speed and the winding speed of the foaming body substrate such that the foaming body substrate is extended to be equal to or greater than the aforementioned amount of the expansion in the flow direction, in consideration of the amount of the expansion in the flow direction due to the foaming of the foaming polyolefin-based resin sheet.

In addition, as the method of extending the foaming body substrate in the width direction, it is preferable to use a method of gripping both end portions of the foaming body substrate in the width direction by using a pair of gripping members and extending the foaming body substrate in the width direction by gradually moving the pair of gripping members in the direction in which the pair of gripping members are separated from each other. Note that, since the foaming polyolefin-based resin sheet is foamed by itself and thus is expanded in the width direction, and thus in a case where the foaming body substrate is extended in the width direction, it is necessary to adjust the supplying speed and the winding speed of the foaming body substrate such that the foaming body substrate is extended to be equal to or greater than the aforementioned amount of the expansion in the width direction, in consideration of the amount of the expansion in the width direction due to the foaming of the foaming polyolefin-based resin sheet.

Here, the extension magnification of the polyolefin-based foaming body in the flow direction is preferably in a range of 1.1 times to 5 times, and further preferably in a range of 1.3 times to 3.5 times such that further excellent flexibility and tensile strength are imparted by adjusting the foaming magnification of the polyolefin-based resin foaming body substrate in a predetermined range.

In addition, the extension magnification in the width direction is preferably in a range of 1.2 times to 4.5 times, and further preferably in a range of 1.5 times to 3.5 times such that further excellent flexibility and tensile strength are imparted by adjusting the foaming magnification of the polyolefin-based resin foaming body substrate in a predetermined range.

The foaming body substrate may be colored in order to realize design properties, light shielding properties, hiding properties, light reflectivity, and light resistance in the double-sided pressure-sensitive adhesive tape. The colorant may be used alone or two or more types thereof may be used in combination.

In a case where the light shielding properties, the hiding properties, and the light resistance are imparted to the pressure-sensitive adhesive tape, the foaming body substrate may be colored in black. Examples of a black colorant include carbon black, graphite, copper oxide, manganese dioxide, aniline black, perylene black, titanium black, cyanine black, activated carbon, ferrite, magnetite, chromium oxide, iron oxide, molybdenum disulfide, a chrome complex, a complex oxide-based black pigment, and an anthraquinone-based organic black pigment. Among them, the carbon black is preferably used in terms of cost, availability, insulating properties, and heat resistance with respect to the temperature in the step of extruding the foaming polyolefin-based resin composition or the step of heating and foaming the foaming polyolefin-based resin composition.

In a case where the design properties, the light reflectivity, and the like are imparted to the pressure-sensitive adhesive tape, the foaming body substrate may be colored in white. Examples of a white colorant include an inorganic white colorant such as titanium oxide, zinc oxide, aluminum oxide, silicon oxide, magnesium oxide, zirconium oxide, calcium oxide, tin oxide, barium oxide, cesium oxide, yttrium oxide, magnesium carbonate, calcium carbonate, barium carbonate, zinc carbonate, aluminum hydroxide, magnesium hydroxide, calcium hydroxide, zinc hydroxide, aluminum silicate, calcium silicate, barium sulfate, calcium sulfate, barium stearate, zinc white, talc, silica, alumina, clay, kaolin, titanium phosphate, mica, gypsum, white carbon, diatomaceous earth, bentonite, lithopone, zeolite, and sericite, and an organic white colorant such as a silicone resin particle, an acrylic resin particle, an urethane resin particle, and a melamine resin particle. Among them, the titanium oxide, the aluminum oxide, and the zinc oxide are preferably used in terms of cost, availability, color tone, and heat resistance with respect to the temperature in the step of extruding the foaming polyolefin-based resin composition or the step of heating and foaming the foaming polyolefin-based resin composition.

In addition, as long as the physical properties of the polyolefin-based resin foaming body substrate are not damaged, a plasticizer, an antioxidant, a foaming auxiliary agent such as zinc oxide, a bubble nucleus modifier, a heat stabilizer, a flame retardant such as aluminum hydroxide and magnesium hydroxide, an antistatic agent, a filler such as a glass or plastic hollow balloon bead, a metallic powder, and a metal compound, a conductive filler, and a thermally conductive filler, which are well-known may be arbitrarily contained in the resin of the foaming polyolefin-based resin composition, as necessary. The polyolefin-based resin foaming body substrate which is used in the pressure-sensitive adhesive tape of the present invention maintains the proper following properties and cushioning properties, and thus is preferably in a range of 0.1% to 10% by mass, and is preferably in a range of 1% to 7% by mass with respect to the polyolefin-based resin.

Note that, in a case where the colorant, the thermal decomposition type foaming agent, and the foaming auxiliary agent are mixed into the foaming polyolefin-based resin composition, in order to suppress color unevenness, abnormal foaming, and foaming failure, it is preferable to perform a master batch in advance by using the foaming polyolefin-based resin composition and a thermoplastic resin having high compatibility with the foaming polyolefin-based resin composition before supplying to the extruder.

In order to improve the adhesiveness between the pressure-sensitive adhesive layer and other layers, the foaming body substrate may be subjected to a corona treatment, a flame treatment, a plasma treatment, a hot air treatment, an ozone-UV treatment, and a surface treatment in which the surface is coated with an easy-adhesion treatment agent. As for the surface treatment, when a wet index by a wet reagent is 36 mN/m or more, is preferably 40 mN/m, and further preferably 48 mN/m, it is possible to obtain the excellent adhesiveness between the foaming body substrate and the pressure-sensitive adhesive. The foaming body substrate having improved adhesiveness may be bonded to the pressure-sensitive adhesive layer in the continuous step, or may be temporarily subjected to a winding process. In a case where the foaming body substrate is temporarily wound, the foaming body substrates having the improved adhesiveness are prevented from blocked to each other, and thus it is preferable that the foaming body substrate is wound with an interleaf such as paper or a film formed of polyethylene, polypropylene, or polyester, and a polypropylene film or a polyester film which has a thickness of 25 μm or less is preferable.

[Resin Film]

The double-sided pressure-sensitive adhesive tape of the present invention includes a layer, which is formed of the above-described resin film, on the both surfaces of the foaming body substrate for forming the double-sided pressure-sensitive adhesive tape. The resin films may be the same as each other, or may be formed of the different materials and thickness from each other.

The resin film is a supporting body at the time of removing a portion of the double-sided pressure-sensitive adhesive tape which remains on the surface of the adherend when a bonded material in which two or more adherends are bonded to each other by using the double-sided pressure-sensitive adhesive tape of the present invention is peeled (disassembled).

Specifically, when the bonded material is peeled (disassembled), a portion of the foaming body substrate for forming the double-sided pressure-sensitive adhesive tape can be disassembled. At this time, a portion of the pressure-sensitive adhesive layer, the resin film, and the foaming body substrate may remain on a portion of the adherend. At the time of removing the residue from the adherend, it is possible to easily remove the residue from the surface of each of the adherends by extending the resin film.

Examples of the resin film include a polyester resin film such as a polyethylene terephthalate film, a polybutylene terephthalate film, a polyethylene naphthalate film, a polyethylene film, a polypropylene film, a cellophane film, a diacetyl cellulose film, a triacetyl cellulose film, an acetyl cellulose butyrate film, a polyvinyl chloride film, a polyvinylidene chloride film, a polyvinyl alcohol film, an ethylene-vinyl acetate copolymer film, a polystyrene film, a polycarbonate film, a polymethylpentene film, a polysulfone film, a polyether ether ketone film, a polyether sulfone film, a polyether imide film, a polyimide film, a fluorine resin film, a nylon film, and a resin film such as an acrylic resin film.

As the resin film, it is possible to use a resin film in which colors, characters, figures, symbols, and the like which are the same as or different from each other are denoted to any one surface or both surfaces thereof so as to easily identify the front and the back of the double-sided pressure-sensitive adhesive tape. The color may be a single color or may be mixed color.

The resin film may be subjected to a corona treatment, a flame treatment, a plasma treatment, a hot air treatment, an ozone UV treatment, and a surface treatment such as the application of an easy-adhesion treatment agent so as to further improve the adhesiveness between the resin film and the foaming body substrate or other layers such as the pressure-sensitive adhesive layer.

The thickness of the resin film is preferably in a range of 0.5 μm to 20 μm, further preferably in a range of 2 μm to 20 μm, further still preferably in a range of 3 μm to 16 μm, and particularly preferably in a range of 3.5 μm to 15 μm. When the thickness is in the aforementioned range, it is possible to realize both preferable impact resistance and disassembly properties, and the preferable following properties with respect to the adherend are easily obtained.

In adhesion of the resin film and the foaming body, for example, it is possible to use an adhesive containing a urethane resin, an adhesive containing an acrylic resin, and an adhesive containing a polyester resin. Among them, as the adhesive, a urethane-based adhesive containing a urethane resin is preferably used, an adhesive containing a polyester-based urethane resin, and an adhesive containing a polyester-based urethane resin are further preferably used, and a urethane-based adhesive containing a polyester-based urethane resin is particularly preferably used from the aspect that the urethane-based adhesive is excellent in the initial adhesive force, and can be boded at a relatively low temperature in a case of using a dry lamination method.

As the urethane-based adhesive, an adhesive containing a urethane resin, and a solvent such as an organic solvent or water can be used.

The urethane resin which is contained in the adhesive can be prepared by reacting polyisocyanate with polyol.

Examples of the polyisocyanate include aromatic polyisocyanate such as 4,4′-diphenylmethane diisocyanate, 2,4′-diphenylmethane diisocyanate, carbodiimide-modified diphenylmethane diisocyanate, crude diphenylmethane diisocyanate, phenylene diisocyanate, tolylene diisocyanate, naphthalene diisocyanate, xylylene diisocyanate, and tetramethyl xylylene diisocyanate, aliphatic polyisocyanate, and polyisocyanate having an aliphatic cyclic structure.

Examples of the polyol which can be reacted with the polyisocyanate include polyether polyol, polyester polyol, and polycarbonate polyol. Among them, the polyether polyol is preferably used.

As the polyether polyol, for example, it is possible to use a material obtained by performing addition polymerization on alkylene oxide by using one or two or more types of compounds having two or more active hydrogen atoms as an initiator.

Examples of the initiator include ethylene glycol, diethylene glycol, triethylene glycol, propylene glycol, trimethylene glycol, 1,3-butanediol, 1,4-butanediol, 1,6-hexanediol, neopentyl glycol, glycerin, trimethylol ethane, and trimethylol propane.

In addition, examples of the alkylene oxide include ethylene oxide, propylene oxide, butylene oxide, styrene oxide, epichlorohydrin, and tetrahydrofuran.

Examples of the polyester polyol include aliphatic polyester polyol and aromatic polyester polyol which are obtained by performing an esterification reaction between a low molecular weight polyol and polycarboxylic acid, polyester obtained by performing a ring-opening polymerization reaction of a cyclic ester compound such as ε-caprolactone or γ-butyrolactone, and copolyester thereof.

Examples of the low molecular weight polyol which can be used in the preparing of the polyester polyol include ethylene glycol, 1,2-propanediol, 1,3-butanediol, 1,4-butanediol, 1,6-hexanediol, 1,4-cyclohexanedimethanol, 3-methyl-1,5-pentanediol, neopentyl glycol, diethylene glycol, dipropylene glycol, glycerin, and trimethylolpropane which can be used alone or in combination of two or more types thereof. It is preferable that ethylene glycol, 1,2-propanediol, 1,3-butanediol, and 1,4-butanediol are used in combination with 3-methyl-1,5-pentanediol and neopentyl glycol.

Examples of the polycarboxylic acid include a succinic acid, an adipic acid, a sebacic acid, a dodecane dicarboxylic acid, an azelaic acid, a cyclopentane dicarboxylic acid, a cyclohexane dicarboxylic acid, a terephthalic acid, an isophthalic acid, a phthalic acid, a naphthalene dicarboxylic acid, and an anhydride thereof or an ester-forming derivative. Among them, an aliphatic polycarboxylic acid such as an adipic acid is preferably used. Note that, in a case where polyester polyol having the aromatic cyclic structure is used, as the polycarboxylic acid, an aromatic polycarboxylic acid such as a terephthalic acid, an isophthalic acid, a phthalic acid, and a naphthalene dicarboxylic acid can be used.

Examples of the polycarbonate polyol which can be used as the polyol include a material obtained by reacting carbonic ester with polyol, and a material obtained by reacting phosgene with bisphenol A or the like.

Examples of the carbonic ester include methyl carbonate, dimethyl carbonate, ethyl carbonate, diethyl carbonate, cyclocarbonate, and diphenyl carbonate.

Examples of the polyol which can be reacted with the carbonic ester include a dihydroxy compound having relatively low molecular weight such as ethylene glycol, diethylene glycol, triethylene glycol, 1,2-propylene glycol, 1,3-propylene glycol, dipropylene glycol, 1,4-butanediol, 1,3-butanediol, 1,2-butanediol, 2, 3-butanediol, 1,5-pentanediol, 1,5-hexanediol, 1,6-hexanediol, 1,7-heptane diol, 1,8-octanediol, 1,9-nonanediol, 1,10-decanediol, 3-methyl-1,5-pentanediol, 2-ethyl-1,3-hexanediol, 2-methyl-1,3-propanediol, 2-methyl-1,8-octanediol, 2-butyl-2-ethyl-propanediol, 2-methyl-1,8-octanediol, neopentyl glycol, 1,4-cyclohexanediol, 1,4-cyclohexanedimethanol, hydroquinone, resorcinol, bisphenol-A, bisphenol-F, and 4,4′-biphenol.

As the polyol, in addition to the polyether polyol, polyester polyol, and polycarbonate polyol, it is possible to use other types of polyol in combination as necessary.

As other polyols, ethylene glycol, 1,2-propanediol, 1,3-butanediol, 1,4-butanediol, 3-methyl-1,5-pentanediol, 1, 6-hexanediol, 1, 4-cyclohexanedimethanol, neopentyl glycol, diethylene glycol, dipropylene glycol, and acrylic polyol which is obtained by introducing a hydroxyl group into an acrylic copolymer can be properly used.

Examples of the method of preparing the urethane resin by reacting the polyisocyanate with the polyol include a method of preparing an urethane resin (A′) having an isocyanate group by reacting the polyisocyanate with the polyol, and then mixing and reacting a chain extender therewith as necessary.

The reaction of the polyisocyanate and the polyol can be performed in the presence of an organic solvent such as methyl ethyl ketone and dimethylformamide or in the absence of a solvent.

The reaction of polyisocyanate and the above-described polyol can be performed by using a method of collectively mixing the polyisocyanate and the polyol, or sequentially supplying any one of the polyisocyanate and the polyol to the other one in a drop wise manner such that the polyisocyanate and the polyol are reacted with each other about 1 hour to 15 hours at the reaction temperature which is preferably in a range of 50° C. to 120° C. and further preferably in a range of 80° C. to 100° C., in consideration of the safety by fully paying attention to sudden heat generation and foaming.

The above-described urethane resin having weight-average molecular weight in a rage of 50,000 to 120,000 is preferably used.

The urethane-based adhesive containing the urethane resin and a curing agent is preferably used.

Examples of the curing agent include an isocyanate curing agent, an epoxy curing agent, a melamine curing agent, a carbodiimide curing agent, an oxazoline curing agent, and an aziridine curing agent. Examples of the method of bonding the foaming body substrate and the resin film by using an adhesive such as the above-described urethane-based adhesive include a dry lamination method, a non-solvent lamination method, and a wet lamination method. Among them, the dry lamination method is preferably used from the aspect that a laminating step can be efficiently performed, and the solvent which may remain on the adhesive layer can be reduced with the dry lamination method.

As the bonding method, specifically, a method performed in such a manner that the resin film is coated with the adhesive by using direct gravure or the like, a solvent contained in the adhesive is dried and removed by using a dryer or the like, and then the adhesive layer is laminated on the foaming body substrate (a dry lamination method) is preferably used.

The drying temperature is preferably in a range of 30° C. to 100° C., and further preferably in a range of 35° C. to 70° C. The temperature at the time of laminating the adhesive layer on the foaming body substrate is preferably in a range of 20° C. to 80° C., and further preferably in a range of 30° C. to 50° C. from the aspect that the resin film and the foaming body substrate can be firmly bonded to each other, and wrinkles are less likely to be generated on the resin film.

The coating amount of the adhesive is preferably in a range of 0.5 g/m² to 10 g/m², further preferably in a range of 2 g/m² to 6 g/m², and still further preferably in a range of 3 g/m² to 5 g/m² which is slightly larger than that in the typical dry lamination method from the aspect that the resin film and the foaming body substrate can be firmly bonded to each other.

In addition, colors which are the same as or different from each other may be denoted to any one surface or both surfaces of the adhesive layer used in laminating the resin films in order to clearly identify the front and the back of the double-sided pressure-sensitive adhesive tape. The color may be a single color or may be mixed color.

[Pressure-Sensitive Adhesive Layer]

The pressure-sensitive adhesive layer used in the present invention is an pressure-sensitive adhesive layer which exhibits a 180° peeling adhesive force of 10 N/20 mm or more, preferably 12 N/20 mm or more, when a pressure-sensitive adhesive tape obtained by providing the pressure-sensitive adhesive layer with a thickness of 25 μm on a polyethylene terephthalate substrate having a thickness of 25 μm, is rolled reciprocatively once on an aluminum plate having a smooth surface with a 2 kg roller (based on JIS-Z0237) under the environment of a temperature of 23° C. and a relative humidity of 65% RH, is left to stand for one hour under the environment of a temperature of 23° C. and a relative humidity of 50% RH, and is then peeled at a peeling rate of 300 mm/min. When the aforementioned pressure-sensitive adhesive layer is used, it is possible to realize the preferable impact resistance, satisfactory interlayer cracking of the foaming body substrate at the time of disassembly, and the preferable disassembly properties with a certain force. The upper limit of the adhesive force is not particularly determined, is preferably 25 N/20 mm or less, and further preferably 20 N/20 mm or less.

The pressure-sensitive adhesive composition for forming the pressure-sensitive adhesive layer of the pressure-sensitive adhesive tape of the present invention can use the pressure-sensitive adhesive composition used for the typical pressure-sensitive adhesive tape. Examples of the aforementioned pressure-sensitive adhesive composition include a (meth)acrylic pressure-sensitive adhesive, a urethane-based pressure-sensitive adhesive, a synthetic rubber-based pressure-sensitive adhesive, a natural rubber-based pressure-sensitive adhesive, and a silicone-based pressure-sensitive adhesive. Among them, the (meth)acrylic pressure-sensitive adhesive is preferably used by setting the acrylic polymer as a base polymer, and mixing an additive such as a tackifier resin and a cross-linking agent into the base polymer as necessary.

Examples of (meth)acrylate which can be used in the preparing of the acrylic polymer include methyl (meth)acrylate, ethyl (meth)acrylate, n-butyl (meth)acrylate, isobutyl (meth)acrylate, t-butyl (meth)acrylate, n-hexyl (meth)acrylate, n-octyl (meth)acrylate, isooctyl (meth)acrylate, isononyl (meth)acrylate, cyclohexyl (meth)acrylate, and (meth)acrylate, 2-ethylhexyl (meth)acrylate which contains an alkyl group having carbon atoms of 1 to 12 and these may be used alone or two or more types thereof may be used in combination. Among them, the (meth)acrylate which contains an alkyl group having carbon atoms of 4 to 12 is preferably used, and (meth)acrylate which contains an alkyl group having carbon atoms of 4 to 8 and having a linear or branched structure is further preferably used. Particularly, as the aforementioned (meth)acrylate, at least one of n-butyl acrylate, and 2-ethylhexyl acrylate is preferably used from the aspect that the adhesiveness with respect to the adherend is easily secured and excellent resistance with respect to cohesion and sebums is realized.

The content of (meth)acrylate which contains an alkyl group having carbon atoms of 1 to 12 is preferably 60% by mass or more, further preferably in a range of 80% to 98.5% by mass, and still further preferably in a range of 90% to 98.5% by mass with respect to the entire amount of the acrylic monomers used at the time of preparing the acrylic polymer.

In addition, a high-polarity vinyl monomer can be used as an acrylic monomer at the time of preparing the acrylic polymer. Examples of the high-polarity vinyl monomer include a vinyl monomer having a hydroxyl group, a vinyl monomer having a carboxy group, and a vinyl monomer having an amide group, and these may be used alone or two or more types thereof may be used in combination.

Examples of a monomer having a hydroxyl group include (meth)acrylate containing a hydroxyl group such as 2-hydroxyethyl (meth)acrylate, 2-hydroxypropyl (meth)acrylate, 4-hydroxybutyl (meth) acrylate, and 6-hydroxyhexyl (meth)acrylate.

Examples of the vinyl monomer having a carboxyl group include an acrylic acid, a methacrylic acid, an itaconic acid, a maleic acid, (meth)acrylic acid dimer, a crotonic acid, and ethylene oxide-modified succinic acid acrylate. Among them, the acrylic acid is preferably used as a copolymer component.

In addition, examples of the monomer having an amide group include N-vinyl pyrrolidone, N-vinyl caprolactam, acryloyl morpholine, acrylamide, and N,N-dimethyl acrylamide.

Examples of other high-polarity vinyl monomers include a sulfonic acid group-containing monomer such as vinyl acetate, ethylene oxide-modified succinic acid acrylate, and a 2-acrylamido-2-methyl propane sulfonic acid.

The using amount of the high-polarity vinyl monomer is preferably in a range of 1.5% to 20% by mass, further preferably in a range of 1.5% to 10% by mass, and still further preferably in a range of 2% to 8% by mass in order to obtain the double-sided pressure-sensitive adhesive tape in which cohesive force, holding force, and adhesion of the pressure-sensitive adhesive are adjusted to be in a suitable range, with respect to the entire amount of monomeric components used at the time of preparing the acrylic polymer.

In addition, in a case where an acrylic polymer and an isocyanate-based cross-linking agent are used as the aforementioned pressure-sensitive adhesive, it is preferable that a functional group which is reacted with the isocyanate group is introduced to the acrylic polymer. At that time, as an available acrylic monomer, for example, a vinyl monomer having a hydroxyl group is preferable, and 2-hydroxyethyl (meth)acrylate, 4-hydroxybutyl (meth)acrylate, and 6-hydroxyhexyl (meth)acrylate are particularly preferable. The using amount of the vinyl monomer having a hydroxyl group which is reacted with the isocyanate-based cross-linking agent is preferably in a range of 0.01% to 1.0% by mass, and is particularly preferably in a range of 0.03% to 0.3% by mass, with respect to the entire amount of monomeric components at the time of preparing the acrylic polymer.

The acrylic polymer can be prepared by polymerizing the monomeric components with a well-known polymerization method such as a solution polymerization method, a bulk polymerization method, a suspension polymerization method, and an emulsion polymerization method.

As the aforementioned polymerization method, the solution polymerization method and the bulk polymerization method are preferably used in order to further improve water resistance of the pressure-sensitive adhesive layer. A method of initiating the polymerization can be selected from any one of an initiating method by heat using a peroxide-based thermal polymerization initiator such as benzoyl peroxide and lauroyl peroxide, and an azo-based thermal polymerization initiator such as azobisisobutyronitrile, an initiating method by ultraviolet irradiation using an acetophenone-based photopolymerization initiator, a benzoin ether-based photopolymerization initiator, a benzil ketal-based photopolymerization initiator, an acylphosphine oxide-based photopolymerization initiator, a benzoin-based photopolymerization initiator, and a benzophenone-based photopolymerization initiator, and a method by electron beam irradiation.

As for the molecular weight of the acrylic polymer, the weight-average molecular weight which is measured by the gel permeation chromatography (GPC) in terms of the standard polystyrene is in a range of 400,000 to 3,000,000, and is preferably in a range of 800,000 to 2,500,000.

Here, the molecular weight by the GPC method is measured by using a GPC apparatus (HLC-8329GPC) manufactured by TOSOH Co., Ltd., in terms of the standard polystyrene, and the measurement conditions are as follows.

Sample concentration: 0.5% by mass (THF solution)

Sample injection amount: 100 μl

Eluent: THF

Flow rate: 1.0 ml/min

Measuring temperature: 40° C.

Main column: TS kgel, two GMHHR-H (20)

Guard column: TS kgel HXL-H

Detector: Differential refractometer

Molecular weight based on the standard polystyrene: 10,000 to 20,000,000 (manufactured by TOSOH Co., Ltd.)

As the pressure-sensitive adhesive used in the present invention, a pressure-sensitive adhesive containing a tackifier resin is preferably used in order to further improve the adhesiveness and the surface adhesion strength with respect to the adherend. Examples of the tackifier resin include a rosin-based resin, a polymerized rosin-based resin, a polymerized rosin ester-based resin, a rosin phenol-based resin, a stabilized rosin ester-based resin, a disproportionated rosin ester-based resin, a hydrogenated rosin ester-based resin, a terpene-based resin, a terpene phenol-based resin, a petroleum-based resin, and a (meth)acrylate-based resin. In a case of using an emulsion type pressure-sensitive adhesive composition, an emulsion type tackifier resin is preferably used.

Among them, the disproportionated rosin ester-based tackifier resin, the polymerized rosin ester-based tackifier resin, the rosin phenolic-based tackifier resin, the hydrogenated rosin ester-based tackifier resin, the (meth)acrylate-based resin, and the terpene phenolic-based resin are preferably used. The tackifier resin may be used alone or two or more types thereof may be used in combination. In addition, these tackifier resins and a petroleum-based resin are preferably used in combination.

A softening point of the tackifier resin is not particularly limited, but is in a range of 30° C. to 180° C., and preferably in a range of 70° C. to 140° C. It is possible to expect high adhesive performance by mixing the tackifier resin having the high softening point. In a case of the (meth)acrylate-based tackifier resin, a glass-transition temperature is in a range of 30° C. to 200° C., and preferably in a range of 50° C. to 160° C.

As for the mixing ratio at the time of using the acrylic polymer and the tackifier resin, the content of the tackifier resin with respect to 100 parts by mass of acrylic polymer is preferably in a range of 5 parts by mass to 65 parts by mass, and is preferably in a range of 8 parts by mass to 55 parts by mass. When the ratio of the acrylic polymer to the tackifier resin is in the above described range, it is easy to secure the adhesiveness with respect to the adherend.

As the pressure-sensitive adhesive of the present invention, a cross-linking agent is preferably used in order to improve cohesion of the pressure-sensitive adhesive layer. Examples of such a cross-linking agent include an isocyanate-based cross-linking agent, an epoxy-based cross-linking agent, a metal chelate-based cross-linking agent, and an aziridine-based cross-linking agent. Among them, the cross-linking agent which is added after polymerization and causes a crosslinking reaction is preferably used, and the isocyanate-based cross-linking agent and the epoxy-based cross-linking agent which are highly reactive with the (meth)acrylic polymer are preferably used, and the isocyanate-based cross-linking agent is further preferably used from the aspect that the adhesiveness is improved with respect to the foaming body substrate.

Examples of the isocyanate-based cross-linking agent include tolylene diisocyanate, naphthylene-1,5-diisocyanate, hexamethylene diisocyanate, diphenylmethane diisocyanate, xylylene diisocyanate, and trimethylolpropane-modified tolylene diisocyanate, and tolylene diisocyanate and a trimethylolpropane adduct thereof are preferably used.

As an index of the degree of cross-linking, a value of gel fraction for measuring insoluble portions of the pressure-sensitive adhesive layer after immersing the pressure-sensitive adhesive layer into toluene for 24 hours is used. The gel fraction is preferably 70% by mass or less. The gel fraction is further preferably in a range of 20% to 60% by mass, and still further preferably in a range of 25% to 55% by mass. When the gel fraction falls within the preferred ranges, both cohesion and adhesion are satisfactory.

Note that, the measurement of the gel fraction is performed as follows. A release sheet is coated with an pressure-sensitive adhesive composition such that the thickness thereof after being dried is 50 μm, dried at 100° C. for three minutes, aged at 40° C. for two days, and cut into a 50 mm×50 mm square. The resultant is set as a sample. Then, the mass (G1) of the sample before being immersed in toluene is measured in advance, toluene insoluble portions of the sample after being immersed in a toluene solution at 23° C. for 24 hours are separated by being filtered through 300 wire mesh, the mass (G2) of residue after drying the separated toluene insoluble portion at 110° C. for one hour is measured, and thus, the gel fraction is calculated by using the following expression.

Gel fraction (% by mass)=(G2/G1)×100

The above-described pressure-sensitive adhesive may contain various types of additives. Examples of the additives include a plasticizer, a softener, an antioxidant, a flame retardant, a filler such as a glass or plastic fiber-balloon bead, metal powders, a metal oxide, and a metal nitride, a colorant such as a pigment and dye, a leveling agent, a thickener, a water repellent, and an anti-foaming agent which are well-known and can be optionally added to a pressure-sensitive adhesive composition.

In the pressure-sensitive adhesive layer for forming the double-sided pressure-sensitive adhesive tape of the present invention, a temperature indicating a peak value of loss tangent (tan δ) at a frequency of 1 Hz is preferably in a range of −40° C. to 15° C. When the peak value of the low tangent of the pressure-sensitive adhesive layer is set to be in the above-described range, it is easy to obtain the excellent adhesiveness with respect to the adherend at a normal temperature. Particularly, at the time of improving drop impact resistance under the low temperature environment, the temperature is further preferably in a range of −35° C. to 10° C., and still further preferably in a range of −30° C. to 6° C.

The loss tangent (tan δ) at the frequency of 1 Hz is calculated by using an expression of tan δ=G″/G′ from storage elastic modulus (G′) and loss elastic modulus (G″) which are obtained by dynamic viscoelastic measurement due to temperature dispersion. The dynamic viscoelasticity is measured by using a viscoelasticity testing machine (manufactured by TA Instruments Japan Ltd., product name: ARES G2) in such a manner that a test piece of the pressure-sensitive adhesive layer having a thickness of about 2 mm is sandwiched between parallel disks having a diameter of 8 mm which are measuring portions of the aforementioned testing machine, and the storage elastic modulus (G′) and the loss elastic modulus (G″) in a range of −50° C. to 150° C. at the frequency of 1 Hz are measured.

From the aspect that it is easy to secure the adhesiveness with respect to the adherend, and vibration properties, the thickness of the pressure-sensitive adhesive layer used in the present invention is preferably in a range of 5 μm to 100 μm, further preferably in a range of 10 μm to 80 μm, and particularly preferably in a range of 15 μm to 80 μm.

[Double-Sided Pressure-Sensitive Adhesive Tape]

The double-sided pressure-sensitive adhesive tape of the present invention which can be obtained by laminating a particular pressure-sensitive adhesive layer and a resin film on a particular foaming body substrate is thin but has preferable impact resistance, and when a certain force is applied, a foaming body substrate generates interlayer crack and thus the double-sided pressure-sensitive adhesive tape can be preferably disassembled. In addition, it is possible to easily peel and remove residue such as adhesive which remains on the surface of the disassembled adherend. For this reason, the double-sided pressure-sensitive adhesive tape can be preferably used for fixing components of a compact electronic device, and particularly can be used for fixing components of a thin plate rigid body such as a protective panel and an image display module of an information display unit of a compact electronic device, and a thin-type battery, to which a large force is easily applied at the time of the disassembly.

Embodiments of the double-sided pressure-sensitive adhesive tape of the present invention are, for example, based on a configuration in which resin films are mainly laminated on both surfaces of the foaming body substrate, and pressure-sensitive adhesive layers are laminated on the surface of the aforementioned resin film. The resin film and the pressure-sensitive adhesive layer may be directly laminated with each other, or may be laminated with other layers interposed therebetween. The embodiments may be properly selected depending on the application, for example, a laminating layer such as a polyester film may be provided in a case of further imparting dimensional stability or the like to the double-sided pressure-sensitive adhesive tape, a light shielding layer may be provided in a case of imparting light shielding properties to the tape, a light reflective layer may be provided in a case of securing light reflectivity, or non-woven fabric which is plated with metal foil or metal having metal mesh conductivity may be provided in a case of imparting electromagnetic shielding properties or thermal conductivity in the plane direction.

As the laminating layer, various types of resin films including a polyester film such as polyethylene terephthalate, a polyethylene film, and a polypropylene film can be used. The thickness thereof is not particularly limited; for example, in terms of following properties of the foaming body substrate, the thickness is preferably in a range of 1 μm to 25 μm, and further preferably in a range of 2 μm to 12 μm. As the laminating layer, a transparent film, a film having the light shielding properties, and a film having reflectivity can be used in accordance with the application. In a case of laminating the foaming body layer with the laminating layer, a conventionally well-known pressure-sensitive adhesive or an adhesive for dry laminating can be used.

As the light shielding layer, a layer formed of ink containing a colorant such as a pigment is conveniently used, and a layer formed of a black ink is preferably used in terms of the excellent light shielding properties. As the light reflective layer, a layer formed of a white ink is conveniently used. The thickness of each of the above-described layers is preferably in a range of 2 μm to 20 μm, and further preferably in a range of 4 μm to 6 μm. When the thickness thereof is set in the aforementioned range, curling of the substrate hardly occurs due to the curing shrinkage of the ink, and workability of the double-sided pressure-sensitive adhesive tape will be excellent.

The double-sided pressure-sensitive adhesive tape of the present invention can be prepared by using a conventionally well-known method. Examples of the well-known method include a direct method performed in such a manner that the surface of each of the resin films laminated on both surfaces of the foaming body substrate is directly coated with the pressure-sensitive adhesive and then the coated surface is dried, and a transfer method performed in such a manner that a release sheet is coated with a pressure-sensitive adhesive composition and the coated sheet is dried so as to form a pressure-sensitive adhesive layer, and then the above-described pressure-sensitive adhesive layer is bonded to the surface of each of the resin films laminated on both surfaces of the foaming body substrate. Note that, in a case where a pressure-sensitive adhesive containing an acrylic polymer and a cross-linking agent is used as the pressure-sensitive adhesive forming the pressure-sensitive adhesive layer, for example, it is preferable that after preparing the double-sided pressure-sensitive adhesive tape by using the above-described methods, the double-sided pressure-sensitive adhesive tape is aged for two days to seven days under the environment of temperature which is preferably in a range of 20° C. to 50° C., and further preferably in a range of 23° C. to 45° C. in order to obtain stable adhesion and pressure-sensitive adhesive properties between the resin film and the pressure-sensitive adhesive layer.

The thickness of the double-sided pressure-sensitive adhesive tape of the present invention may be properly adjusted depending on the application; for example, the thickness is preferably 300 μm or less from the aspect that it is easy to contribute to the thinning of the compact electronic device, is further preferably in a range of 80 μm to 300 μm, and still further preferably in a range of 100 μm to 300 μm. The double-sided pressure-sensitive adhesive tape of the present invention is thin but has the preferable impact resistance and disassembly properties.

The release sheet may be provided as the double-sided pressure-sensitive adhesive sheet of the present invention, and the release sheet is not particularly limited, for example, a synthetic resin film such as a polyethylene film, a polypropylene film, and a polyester film, paper, non-woven fabric, fabric, a foaming sheet or metal foil, and a material in which at least one surface of the substrate such as the above-described laminated body is subjected to a release treatment such as a silicone-based treatment, a long-chain alkyl-based treatment, and a fluorine-based treatment in order to improve release properties from the pressure-sensitive adhesive can be exemplified.

Among them, a release sheet in which high-quality paper in which polyethylene having a thickness of 10 μm to 40 μm is laminated on both surfaces thereof, or one surface or both surfaces of the substrate of the polyester film are subjected to the silicone-based release treatment is preferably used.

As the release sheet, it is possible to use a release sheet in which colors, characters, figures, symbols, and the like which are the same as or different from each other are denoted to any one surface or both surfaces of each release sheet laminated on the pressure-sensitive adhesive layer so as to easily identify the difference between the respective pressure-sensitive adhesive layers for forming the double-sided pressure-sensitive adhesive tape. The color may be a single color or may be mixed color.

The double-sided pressure-sensitive adhesive tape of the present invention has further preferable impact resistance and disassembly properties with the above described configuration, and thus can be preferably used to fix components of the compact electronic device, for example, a protective panel and an image display module of an information display unit in a compact electronic device, a thin-type battery, a speaker, a receiver, a piezoelectric element, a printed circuit board, a flexible printed circuit board (FPC), a digital camera module, sensors, other modules, components made of cushion rubber such as polyurethane or polyolefin, components for decoration, and various types of components. Particularly, the double-sided pressure-sensitive adhesive tape of the present invention can be properly used to fix rigid body components such as a protective panel or an image display module of an information display unit, and a thin-type battery of a compact electronic device.

### EXAMPLES

### (Preparation of Pressure-Sensitive Adhesive Composition (A)

97.97 parts by mass of n-butyl acrylate, 2.0 parts by mass of acrylic acid, 0.03 parts by mass of 4-hydroxy-butyl acrylate, and 0.1 parts by mass of 2,2′-azobisisobutyronitrile as a polymerization initiator were dissolved in a solvent composed of 100 parts by mass of ethyl acetate, and then were polymerized at 70° C. for 12 hours in a reaction container equipped with a stirrer, a reflux condenser, a thermometer, a dropping funnel and a nitrogen gas inlet, and thus, an acrylic copolymer having weight-average molecular weight of 2,000,000 (in terms of polystyrene) was obtained. Subsequently, 25 parts by mass of “SUPER ESTER A100” (disproportionated rosin glycerol ester) manufactured by Arakawa Chemical Industries, Ltd., 5 parts by mass of “PENSEL D135” (polymerized rosin pentaerythritol ester) manufactured by Arakawa Chemical Industries, Ltd., 20 parts by mass of “FTR6100” (a styrene-based petroleum resin) manufactured by Mitsui Chemicals Inc. were added to 100 parts by mass of acrylic copolymer, and ethyl acetate was added thereto and the resultant was uniformly mixed to thereby obtain a pressure-sensitive adhesive composition (a) having nonvolatile content of 40% by mass.

100 Parts by mass of the above-described pressure-sensitive adhesive composition (a) and 1.3 parts by mass of “CORONATE L-45” (an isocyanate-based cross-linking agent, nonvolatile content of 45% by mass) manufactured by Nippon Polyurethane Industry Co., Ltd. were mixed with each other, then the mixture was stirred for 15 minutes, and thus, a pressure-sensitive adhesive (A) was obtained. A 180° peeling adhesive force of the pressure-sensitive adhesive (A) was 12 N/20 mm. The 180° peeling adhesive force is a value measured by the following method.

[180° Peeling Adhesive Force of Pressure-Sensitive Adhesive Layer]

A release-treated surface of a polyethylene terephthalate film having a thickness of 75 μm, which was subjected to a release treatment, was coated with the pressure-sensitive adhesive (A) such that the thickness of the pressure-sensitive adhesive layer after being dried became 25 μm, was dried at 80° C. for three minutes, was bonded to a polyethylene terephthalate substrate which has a thickness of 25 μm and has a smooth surface, was aged for 48 hours under the environment of 40° C., and thus, a pressure-sensitive adhesive tape was obtained.

The pressure-sensitive adhesive tape was rolled reciprocatively once on the aluminum plate having a smooth surface with the 2 kg roller (based on JIS-Z0237) under the environment of a temperature of 23° C. and a relative humidity of 65% RH, was left to stand for one hour under the environment of a temperature of 23° C. and a relative humidity of 50% RH, and was then peeled at a peeling rate of 300 mm/min so as to measure a strength of the 180° peeling adhesive force. The 180° peeling adhesive force of the pressure-sensitive adhesive layer formed by using each of the pressure-sensitive adhesives (B) to (D) described below was also measured by the same method as described above.

(Preparation of Pressure-Sensitive Adhesive Composition (B))

93.4 parts by mass of n-butyl acrylate, 3.5 parts by mass of acrylic acid, 3 parts by mass of vinyl acetate, 0.1 parts by mass of 2-hydroxy-ethyl acrylate, and 0.1 parts by mass of 2,2′-azobisisobutyronitrile as a polymerization initiator were dissolved in a solvent composed of 100 parts by mass of ethyl acetate, and then were polymerized at 70° C. for 12 hours in a reaction container equipped with a stirrer, a reflux condenser, a thermometer, a dropping funnel, and a nitrogen gas inlet, and thus, an acrylic copolymer having weight-average molecular weight of 1,600,000 (in terms of polystyrene) was obtained. Subsequently, 30 parts by mass of “SUPER ESTER A100” (disproportionated rosin glycerol ester) manufactured by Arakawa Chemical Industries, Ltd., 25 parts by mass of “FTR6100” (a styrene-based petroleum resin) manufactured by Mitsui Chemicals Inc., and 5 parts by mass of “PENSEL D135” (polymerized rosin pentaerythritol ester) manufactured by Arakawa Chemical Industries, Ltd. were added to 100 parts by mass of acrylic copolymer, and ethyl acetate was added thereto and the resultant was uniformly mixed to thereby obtain a pressure-sensitive adhesive composition (b) having nonvolatile content of 38% by mass.

100 Parts by mass of the above-described pressure-sensitive adhesive composition (b) and 1.3 parts by mass of “CORONATE L-45” (an isocyanate-based cross-linking agent, nonvolatile content of 45% by mass) manufactured by Nippon Polyurethane Industry Co., Ltd. were mixed with each other, then the mixture was stirred for 15 minutes, and thus, a pressure-sensitive adhesive (B) was obtained. A 180° peeling adhesive force of the pressure-sensitive adhesive (B) was 13.7 N/20 mm.

(Preparation of Pressure-Sensitive Adhesive Composition (C))

44.94 parts by mass of n-butyl acrylate, 50 parts by mass of 2-ethylhexyl acrylate, 3 parts by mass of vinyl acetate, 2 parts by mass of acrylic acid, 0.06 parts by mass of 4-hydroxy-butyl acrylate, and 0.1 parts by mass of 2,2′-azobisisobutyronitrile as a polymerization initiator were dissolved in a solvent composed of 100 parts by mass of ethyl acetate, and then were polymerized at 70° C. for 12 hours in a reaction container equipped with a stirrer, a reflux condenser, a thermometer, a dropping funnel, and a nitrogen gas inlet, and thus, an acrylic copolymer having weight-average molecular weight of 1,200,000 (in terms of polystyrene) was obtained. Subsequently, 10 parts by mass of “PENSEL D135” (polymerized rosin pentaerythritol ester) manufactured by Arakawa Chemical Industries, Ltd. were added to 100 parts by mass of acrylic copolymer, and ethyl acetate was added thereto and the resultant was uniformly mixed to thereby obtain a pressure-sensitive adhesive composition (c) having nonvolatile content of 45% by mass.

100 Parts by mass of the above-described pressure-sensitive adhesive composition (c) and 1.3 parts by mass of “CORONATE L-45” (an isocyanate-based cross-linking agent, nonvolatile content of 45% by mass) manufactured by Nippon Polyurethane Industry Co., Ltd. were mixed with each other, then the mixture was stirred for 15 minutes, and thus, a pressure-sensitive adhesive (C) was obtained. A 180° peeling adhesive force of the pressure-sensitive adhesive (C) was 8.9 N/20 mm.

(Preparation of Pressure-Sensitive Adhesive Composition (D))

93.4 parts by mass of n-butyl acrylate, 3.5 parts by mass of acrylic acid, 3 parts by mass of vinyl acetate, 0.1 parts by mass of 2-hydroxy-ethyl acrylate, and 0.1 parts by mass of 2,2′-azobisisobutyronitrile as a polymerization initiator were dissolved in a solvent composed of 100 parts by mass of ethyl acetate, and then were polymerized at 70° C. for 12 hours in a reaction container equipped with a stirrer, a reflux condenser, a thermometer, a dropping funnel, and a nitrogen gas inlet, and thus, an acrylic copolymer having weight-average molecular weight of 1,600,000 (in terms of polystyrene) was obtained.

Subsequently, 9.4 parts by mass of “SUPER ESTER A100” (disproportionated rosin glycerol ester) manufactured by Arakawa Chemical Industries, Ltd. and 9.4 parts by mass of “HARITACK PCJ” (polymerized rosin pentaerythritol ester) manufactured by Harima Chemicals Group, Inc. were added to 100 parts by mass of acrylic copolymer, and ethyl acetate was added thereto and the resultant was uniformly mixed to thereby obtain a pressure-sensitive adhesive composition (d) having nonvolatile content of 38% by mass.

100 Parts by mass of the above-described pressure-sensitive adhesive composition (d) and 1.3 parts by mass of “CORONATE L-45” (an isocyanate-based cross-linking agent, nonvolatile content of 45% by mass) manufactured by Nippon Polyurethane Industry Co., Ltd. were mixed with each other, then the mixture was stirred for 15 minutes, and thus, a pressure-sensitive adhesive (D) was obtained. A 180° peeling adhesive force of the pressure-sensitive adhesive (D) was 8.5 N/20 mm.

### Example 1

A release-treated surface of a polyethylene terephthalate film having a thickness of 75 μm, which was subjected to a release treatment, was coated with the pressure-sensitive adhesive (A) prepared in the above description such that the thickness of the pressure-sensitive adhesive layer after being dried became 15 μm, was dried at 80° C. for three minutes, and thus, two polyethylene terephthalate films containing a pressure-sensitive adhesive layer having a thickness of 15 μm were prepared.

Then, a resin film formed of polyethylene terephthalate (thickness of 6 μm) was laminated on both surfaces of substrate formed of a black polyolefin-based foaming body (1) manufactured by Sekisui Chemical Co., Ltd. (thickness: 100 μm, density: 0.40 g/cm³, interlaminar strength: 12.6 N/cm, 25% compressive strength: 103 kPa, tensile strength in flow direction: 1084 N/cm², tensile strength in width direction: 790 N/cm², and wetting index of surface which was subjected to corona treatment: 54 mN/m), by using a urethane-based adhesive described below, and thus, a laminated body was prepared.

As the aforementioned urethane-based adhesive, a urethane-based adhesive (α) composed of a dimethyl formamide solution [30% by mass of nonvolatile content] of an urethane resin having weight-average molecular weight of 100,000 obtained by the reaction of polyester polyol having number average molecular weight of 2,000 obtained by reacting 1,4-butane diol, neopentyl glycol, and an adipic acid with each other, polyoxytetramethylene glycol, ethylene glycol, and 4,4′-diphenylmethane diisocyanate was used.

The polyethylene terephthalate film containing the pressure-sensitive adhesive layer having a thickness of 15 μm was bonded to and laminated on both surfaces of the laminated body by using a roller under a temperature of 23° C. and a linear pressure of 5 kg/cm. Thereafter, the laminated body was aged for 48 hours under the environment of 40° C. so as to obtain a double-sided pressure-sensitive adhesive tape having a thickness of 150 μm. Note that, a gel fraction of the pressure-sensitive adhesive (A) layer for forming the double-sided pressure-sensitive adhesive tape was 42.5% by mass. The aforementioned gel fraction was calculated based on the difference between the masses of the double-sided pressure-sensitive adhesive tape before and after being immersed into toluene for 24 hours at room temperature. Hereinafter, the gel fraction in the case of using each of the pressure-sensitive adhesives (B) to (D) was also calculated by using the same method as described above.

### Example 2

A double-sided pressure-sensitive adhesive tape having a thickness of 200 μm was obtained by using the same method as that in Example 1 except that the thickness of the pressure-sensitive adhesive layer after being dried was changed to 40 μm.

### Example 3

A double-sided pressure-sensitive adhesive tape having a thickness of 150 μm was obtained by using the same method as that in Example 1 except that a black polyolefin-based foaming body (2) manufactured by Sekisui Chemical Co., Ltd. (thickness: 80 μm, density: 0.40 g/cm³, interlaminar strength: 10.2 N/cm, 25% compressive strength: 92 kPa, tensile strength in flow direction: 1062 N/cm², tensile strength in width direction: 962 N/cm², and wetting index of surface which was subjected to corona treatment: 54 mN/m) was used instead of the black polyolefin-based foaming body (1), and the thickness of the pressure-sensitive adhesive layer after being dried was changed to 25 μm.

### Example 4

A double-sided pressure-sensitive adhesive tape having a thickness of 150 μm was obtained by using the same method as that in Example 1 except that a black polyolefin-based foaming body (3) manufactured by Sekisui Chemical Co., Ltd. (thickness: 100 μm, density: 0.45 g/cm³, interlaminar strength: 16.2 N/cm, 25% compressive strength: 190 kPa, tensile strength in flow direction: 964 N/cm², tensile strength in width direction: 861 N/cm², and wetting index of surface which was subjected to corona treatment: 54 mN/m) was used instead of the black polyolefin-based foaming body (1).

### Example 5

A double-sided pressure-sensitive adhesive tape having a thickness of 200 μm was obtained by using the same method as that in Example 1 except that a black polyolefin-based foaming body (3) manufactured by Sekisui Chemical Co., Ltd. (thickness: 100 μm, density: 0.45 g/cm³, interlaminar strength: 16.2 N/cm, 25% compressive strength: 190 kPa, tensile strength in flow direction: 964 N/cm², tensile strength in width direction: 861 N/cm², and wetting index of surface which was subjected to corona treatment: 54 mN/m) was used instead of the black polyolefin-based foaming body (1), and the thickness of the pressure-sensitive adhesive layer after being dried was changed to 40 μm.

### Example 6

A double-sided pressure-sensitive adhesive tape having a thickness of 200 μm was obtained by using the same method as that in Example 1 except that a black polyolefin-based foaming body (4) manufactured by Sekisui Chemical Co., Ltd. (thickness: 120 μm, density: 0.40 g/cm³, interlaminar strength: 17.5 N/cm, 25% compressive strength: 116 kPa, tensile strength in flow direction: 1023 N/cm², tensile strength in width direction: 740 N/cm², and wetting index of surface which was subjected to corona treatment: 54 mN/m) was used instead of the black polyolefin-based foaming body (1), and the thickness of the pressure-sensitive adhesive layer after being dried was changed to 30 μm.

### Example 7

A double-sided pressure-sensitive adhesive tape having a thickness of 200 μm was obtained by using the same method as that in Example 1 except that a black polyolefin-based foaming body (5) manufactured by Sekisui Chemical Co., Ltd. (thickness: 140 μm, density: 0.40 g/cm³, interlaminar strength: 19.1 N/cm, 25% compressive strength: 130 kPa, tensile strength in flow direction: 994 N/cm², tensile strength in width direction: 713 N/cm², and wetting index of surface which was subjected to corona treatment: 54 mN/m) was used instead of the black polyolefin-based foaming body (1), and the thickness of the pressure-sensitive adhesive layer after being dried was changed to 20 μm.

### Example 8

A double-sided pressure-sensitive adhesive tape having a thickness of 200 μm was obtained by using the same method as that in Example 1 except that a resin film formed of polyethylene terephthalate (thickness of 3 μm) was used instead of the resin film formed of polyethylene terephthalate (thickness of 6 μm), and the thickness of the pressure-sensitive adhesive layer after being dried was changed to 43 μm.

### Example 9

A double-sided pressure-sensitive adhesive tape having a thickness of 200 μm was obtained by using the same method as that in Example 1 except that a resin film formed of polyethylene terephthalate (thickness of 16 μm) was used instead of the resin film formed of polyethylene terephthalate (thickness of 6 μm), and the thickness of the pressure-sensitive adhesive layer after being dried was changed to 30 μm.

### Example 10

A double-sided pressure-sensitive adhesive tape having a thickness of 150 μm was obtained by using the same method as that in Example 1 except that the pressure-sensitive adhesive composition (B) was used instead of the pressure-sensitive adhesive composition (A). The gel fraction of the pressure-sensitive adhesive (B) layer for forming the double-sided pressure-sensitive adhesive tape was 37% by mass.

### Comparative Example 1

A release-treated surface of a polyethylene terephthalate film having a thickness of 75 μm, which was subjected to a release treatment, was coated with the pressure-sensitive adhesive (A) prepared in the above description such that the thickness of the pressure-sensitive adhesive layer after being dried became 15 μm, the coated surface was dried at 80° C. for three minutes, and thus, one polyethylene terephthalate film containing a pressure-sensitive adhesive layer having a thickness of 15 μm was prepared.

In addition, a release-treated surface of a polyethylene terephthalate film having a thickness of 75 μm, which was subjected to a release treatment, was coated with the pressure-sensitive adhesive (A) prepared in the above description such that the thickness of the pressure-sensitive adhesive layer after being dried became 25 μm, was dried at 80° C. for three minutes, and thus, one polyethylene terephthalate film containing a pressure-sensitive adhesive layer having a thickness of 25 μm was prepared.

Then, a resin film formed of polyethylene terephthalate (thickness of 6 μm) was laminated on one surface of substrate formed of a black polyolefin-based foaming body (1) manufactured by Sekisui Chemical Co., Ltd. (thickness: 100 μm, density: 0.40 g/cm³, interlaminar strength: 12.6 N/cm, 25% compressive strength: 103 kPa, tensile strength in flow direction: 1084 N/cm², tensile strength in width direction: 790 N/cm², and wetting index of surface which was subjected to corona treatment: 54 mN/m) by using the same adhesive as the urethane-based adhesive (α) used in Example 1, and thus, a laminated body was prepared.

The polyethylene terephthalate film containing the pressure-sensitive adhesive layer having a thickness of 25 μm was bonded onto the surface of the side of the resin film which forms the above-described laminated body, then the polyethylene terephthalate film containing the pressure-sensitive adhesive layer having a thickness of 15 μm was bonded onto the surface of the side of the foaming body substrate which forms the above-described laminated body, and thereafter, the polyethylene terephthalate films were laminated on the surface by using a roller under a temperature of 23° C. and a linear pressure of 5 kg/cm. Thereafter, the laminated body was aged for 48 hours under the environment of 40° C. so as to obtain a double-sided pressure-sensitive adhesive tape having a thickness of 150 μm.

### Comparative Example 2

A double-sided pressure-sensitive adhesive tape having a thickness of 150 μm was obtained by using the same method as that in Comparative Example 1 except that a black polyolefin-based foaming body (6) manufactured by Sekisui Chemical Co., Ltd. (thickness: 100 μm, density: 0.50 g/cm³, interlaminar strength: 13.6 N/cm, 25% compressive strength: 270 kPa, tensile strength in flow direction: 1456 N/cm², tensile strength in width direction: 956 N/cm², and wetting index of the surface which was subjected to corona treatment: 54 mN/m) was used instead of the black polyolefin-based foaming body (1).

### Comparative Example 3

A double-sided pressure-sensitive adhesive tape having a thickness of 150 μm was obtained by using the same method as that in Comparative Example 1 except that the pressure-sensitive adhesive composition (C) was used instead of the pressure-sensitive adhesive composition (A). The gel fraction of the pressure-sensitive adhesive layer was 38% by mass.

### Comparative Example 4

A double-sided pressure-sensitive adhesive tape having a thickness of 200 μm was obtained by using the same method as that in Example 1 except that a black polyolefin-based foaming body (4) was used instead of the black polyolefin-based foaming body (1), the pressure-sensitive adhesive composition (D) was used instead of the pressure-sensitive adhesive composition (A), the thickness (the resin film side) of the pressure-sensitive adhesive layer after being dried was changed to 30 μm, and the thickness (the foaming body substrate side) of the pressure-sensitive adhesive layer after being dried was changed to 20 μm. The gel fraction of the pressure-sensitive adhesive layer was 48% by mass.

### Comparative Example 5

A double-sided pressure-sensitive adhesive tape having a thickness of 150 μm was obtained by using the same method as that in Example 1 except that the resin film was not used, and the thickness of both surfaces of the pressure-sensitive adhesive layer after being dried was changed to 25 μm.

The evaluation of the foaming body substrate which was used in the examples and comparative examples, the double-sided pressure-sensitive adhesive tape which was obtained in the examples and comparative examples was performed as follows. The obtained results are indicated in tables.

[Thickness of Foaming Body Substrate and Pressure-Sensitive Adhesive Tape]

The measurement was performed by using “DIAL-SIK GAUGE G TYPE” manufactured by Ozaki Mfg. Co., Ltd. In a case of the pressure-sensitive adhesive tape, the measurement was performed after peeling a release film.

[Density of Foaming Body Substrate]

The density was measured based on JISK6767. Approximately 15 cm³ of foaming body substrate which was cut into a rectangular shape of 4 cm×5 cm was prepared and the mass thereof was measured to obtain the density.

[Interlaminar Strength of Foaming Body Substrate]

A pressure-sensitive adhesive layer having a thickness of 50 μm and strongly pressure-sensitive adhesive properties (it was not peeled from an adherend and a foaming body substrate when performing the following high-speed peeling test) was bonded on each of both surfaces of the foaming body substrate and then aging was performed at 40° C. for 48 hours so as to prepare a double-sided pressure-sensitive adhesive tape for measuring interlaminar strength. Next, a sample of the double-sided pressure-sensitive adhesive tape having the width of 1 cm and the length of 15 cm (in the flow direction and the width direction of the foaming body substrate) in which the pressure-sensitive adhesive surface on one side was backed with a polyester film having a thickness of 25 μm was rolled reciprocatively once on a polyester film having a thickness of 50 μm, the width of 3 cm, and the length of 20 cm under the conditions of 23° C. and 50% RH with a 2 kg roller to perform bonding with pressure, and then was left to stand for 48 hours at 60° C. After the sample was further left to stand for 24 hours at 23° C., the side to which the polyester film having a thickness of 50 μm was bonded under the conditions of 23° C. and 50% RH was fixed to a mounting jig of a high-speed peeling tester, and then the polyester film having a thickness of 25 μm was pulled in the 90° direction at a tension rate of 15 m/min so as to measure the maximum strength when the foaming body was torn.

[Tensile Strength of Foaming Body Substrate]

The tensile strength of the foaming body substrate in the flow direction and the width direction was measured based on JISK6767. The tensile strength was obtained by measuring the foaming body substrate having a length of 2 cm between the marked lines and a width of 1 cm under the measurement condition of a tension rate of 300 mm/min in the environment of a temperature of 23° C. and a relative humidity of 50% RH by using a Tensilon tensile tester. The maximum strength of the obtained measured value was the tensile strength of the foaming body substrate.

[25% Compressive Strength of Foaming Body Substrate]

25% compressive strength of the foaming body substrate was measured based on JISK6767. A sample which was cut into a 25×25 square was laminated until the thickness became about 10 mm. The foaming body substrate was sandwiched by stainless steel plates each having an area larger than that of the foaming body substrate, and then the strength when the foaming body substrate was compressed by about 2.5 mm (25% fraction of the original thickness) was measured at a speed of 10 mm/min at 23° C.

[Measuring of Average Foam Diameter of Foaming Body Substrate]

First, the foaming body substrate was cut into a 1 cm×1 cm square in the width direction and the flow direction. Subsequently, a portion of bubbles of foaming body in a center portion of the cutting surface of the cut foaming body substrate was magnified by 200 times by using a digital microscope (product name “KH-7700” manufactured by HiROX Co., Ltd.), and then the length of the cross-section of the foaming body substrate in the width direction or the flow direction and the entire length of the cross-section of the foaming body substrate in the thickness direction were observed. In the obtained magnified image, the bubble diameters of the entirety of bubbles existing in the cutting surface of which the actual length was 2 mm in the flow direction or the width direction before magnifying were measured, and the average foam diameter was calculated by using the average value thereof. The average foam diameter was obtained based on the average values by measuring ten portions of the cutting surface selected arbitrarily.

[Easy Disassembly]

1) The double-sided pressure-sensitive adhesive tapes obtained in the examples and comparative examples each was cut such that the length was 2 cm (the flow direction of the foaming body substrate) and the width was 1 cm. With respect to each of the double-sided pressure-sensitive adhesive tapes, two cut double-sided pressure-sensitive adhesive tapes were bonded to the center of a polycarbonate plate in which the length was 2.5 cm in the vertical direction, the length was 4.0 cm in the horizontal direction, and the thickness was 2 mm at a distance of 2 cm in the width direction.

2) An end portion of the polyethylene terephthalate film having the length of 20 cm, the width of 1.5 cm, and the thickness of 50 μm was fixed onto a back surface opposite to a surface on which tapes were bonded of the above-described polycarbonate plate, and the polyethylene terephthalate film was wound so as to pass through the two double-sided pressure-sensitive adhesive tapes. At that time, the center of the width of the polyethylene terephthalate film was set to match with the center of the two double-sided pressure-sensitive adhesive tapes.

3) The polycarbonate plate onto which the polyethylene terephthalate film was wound and fixed was bonded onto a surface of an aluminum plate such that the double-sided pressure-sensitive adhesive tapes came in contact with the aluminum plate having 20 cm×20 cm, and then compression was performed by using 2 kg of weight to perform bonding with pressure, followed by being left to stand for 72 hours at 23° C. and 50% RH, and thus, the resultant was set as a test piece. Note that, at the time of preparing the above-described test piece by using each of the double-sided pressure-sensitive adhesive tapes obtained in Comparative Examples 1 to 4, the pressure-sensitive adhesive layer on the side of the resin film for forming the double-sided pressure-sensitive adhesive tape was provided to come in contact with the aluminum plate.

4) The end portion of the polyethylene terephthalate film of the test piece was pulled in the 90° direction with respect to the aluminum plate so as to peel the polycarbonate plate. At this time, the peeling state of the double-sided pressure-sensitive adhesive tape was observed.

EXCELLENT: Whole surface (100%) of the double-sided pressure-sensitive adhesive tape was destroyed between layers of the foaming body substrate to thereby perform peeling.

GOOD: 90% or more and less than 100% of the double-sided pressure-sensitive adhesive tape was destroyed between layers of the foaming body substrate to thereby perform peeling.

POOR: Less than 90% of the double-sided pressure-sensitive adhesive tape was destroyed between layers of the foaming body substrate.

[Peeling Properties]

After performing the test of the above-described easy disassembly, an end portion of a portion (residue) of the double-sided pressure-sensitive adhesive tape which remained on the surface of each adherend was picked up, and was slowly peeled in the 135° direction at a speed of 600 mm/min by hand. Specifically, a portion of the double-sided pressure-sensitive adhesive tape which remained on the surface of the polycarbonate plate (adherend B), and a portion of the double-sided pressure-sensitive adhesive tape which remained on the surface of the aluminum plate (adherend A) were peeled by hand and the easiness of peeling was evaluated.

EXCELLENT: The entirety (100%) of the double-sided pressure-sensitive adhesive tape was peeled and removed from the surface of the adherend.

GOOD: 90% or more and less than 100% of residue of the double-sided pressure-sensitive adhesive tape was peeled and removed from the surface of the adherend.

NORMAL: 50% or more and less than 90% of residue of the double-sided pressure-sensitive adhesive tape was peeled and removed from the surface of the adherend.

POOR: Less than 50% of residue of the double-sided pressure-sensitive adhesive tape was peeled and removed from the surface of the adherend.

[Test of Impact Resistance]

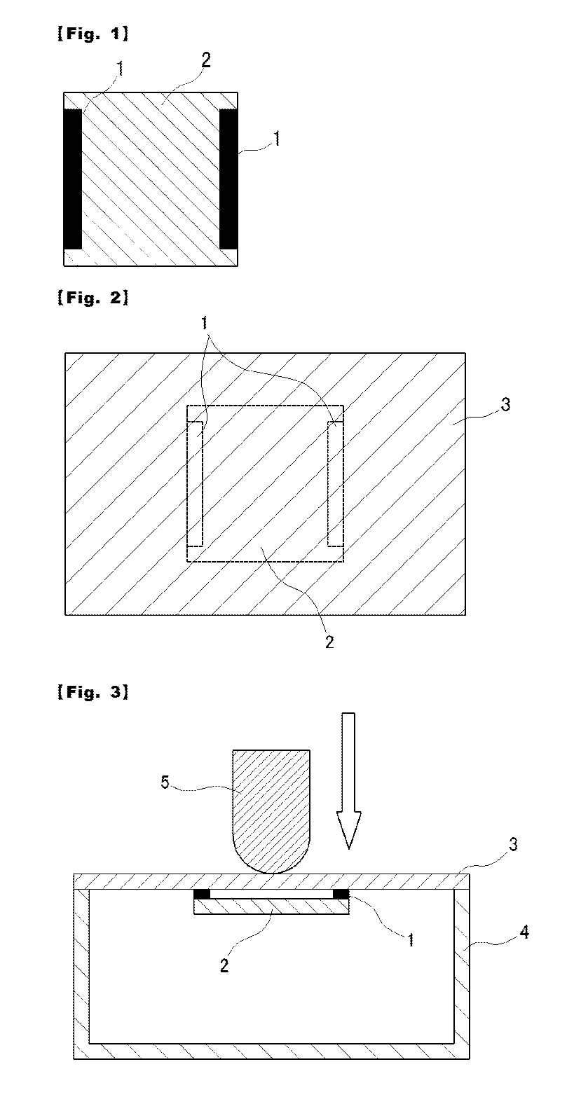

1) Weak pressure-sensitive adhesive surfaces of two double-sided pressure-sensitive adhesive tapes having the length of 40 mm and the width of 5 mm were bonded to an acrylic plate having a thickness of 2 mm, and a size of 50 mm×50 mm (ACRYLITE L “product name” manufactured by Mitsubishi Rayon Co., Ltd., hue: transparent) in parallel at a distance of 40 mm (refer to FIG. 1), and then were bonded to the center portion of an ABS plate (TAFUESU R “product name” manufactured by Sumitomo Bakelite Co., Ltd., hue: natural, no grain, the same applies to the following) having a thickness of 2 mm and the appearance of 150 mm×100 mm (refer to FIG. 2), was applied with pressure by being rolled reciprocatively once with a 2 kg roller, and was left to stand for one hour at 23° C., thereby obtaining a test piece.

2) A U-shaped measuring table (formed of aluminum having a thickness of 5 mm) having the length of 150 mm, the width of 100 mm, and the height of 45 mm was installed on a pedestal of DuPont impact tester (manufactured by Tester Sangyo Co., Ltd.), and the test piece was placed on the U-shaped measuring table while the acrylic plate was directed downward (refer to FIG. 3). An impact base formed of a stainless steel having a diameter of 25 mm and a mass of 300 g was dropped on the central part of the ABS plate from the ABS plate side five times in 10-second intervals, with respect to each of the heights which were varied in increments of 10 cm, and when the tape of the test piece was peeled or destroyed, the height was measured.

GOOD: As a result of the test, the tape was not peeled or destroyed when the height was 60 cm.

POOR: The tape was peeled or destroyed when the height was 60 cm or less.

TABLE 1

| | | | Example 1 | Example 2 | Example 3 | Example 4 | Example 5 |
|---|---|---|---|---|---|---|---|
| Foaming | Types | | (1) | (1) | (2) | (3) | (3) |
| body | Thickness | [μm] | 100 | 100 | 80 | 100 | 100 |
| substrate | Apparent Density | [g/cm³] | 0.40 | 0.40 | 0.40 | 0.45 | 0.45 |
| | Interlaminar strength | [N/cm] | 12.6 | 12.6 | 10.2 | 16.2 | 16.2 |
| | 25% compressive strength | [kPa] | 103 | 103 | 92 | 190 | 190 |

| | | | | | | | |
|---|---|---|---|---|---|---|---|
| Tensile | Flow direction | [N/cm³] | 1084 | 1084 | 1062 | 964 | 964 |
| strength | Width direction | [N/cm³] | 790 | 790 | 962 | 861 | 861 |
| Tensile | Flow direction | % | 508 | 508 | 465 | 490 | 490 |
| elongation | Width direction | % | 224 | 224 | 211 | 299 | 299 |
| Average | Thickness direction | [μm] | 20 | 20 | 9 | 25 | 25 |
| bubble | Flow direction | [μm] | 126 | 126 | 117 | 121 | 121 |
| diameter | Width direction | [μm] | 143 | 143 | 225 | 158 | 158 |

| Resin | Types | | α | α | α | α | α |
|---|---|---|---|---|---|---|---|
| film | Thickness of resin film | [μm] | 6 | 6 | 6 | 6 | 6 |
| | Thickness of adhesive layer | [μm] | 4 | 4 | 4 | 4 | 4 |
| Pressure- | Types | | A | A | A | A | A |
| sensitive | Gel fraction | [% by mass] | 42.5 | 42.5 | 42.5 | 42.5 | 42.5 |
| adhesive | Thickness | [μm] | 15 | 40 | 25 | 15 | 40 |
| layer | 180° peeling adhesive force | [N/20 mm] | 12.0 | 12.0 | 12.0 | 12.0 | 12.0 |

| | | | | | | |
|---|---|---|---|---|---|---|
| Total thickness | [μm] | 150 | 200 | 150 | 150 | 200 |
| Easy disassembly | | EXCELLENT | EXCELLENT | EXCELLENT | GOOD | GOOD |
| Peeling properties | Adherend A | EXCELLENT | EXCELLENT | EXCELLENT | EXCELLENT | EXCELLENT |
| | Adherend B | EXCELLENT | EXCELLENT | EXCELLENT | EXCELLENT | EXCELLENT |

| | | | | | |
|---|---|---|---|---|---|
| Impact resistance | GOOD | GOOD | GOOD | GOOD | GOOD |

TABLE 2

| | | | | Example 6 | Example 7 | Example 8 | Example 9 | Example 10 |
|---|---|---|---|---|---|---|---|---|
| Foaming | Types | | | (4) | (5) | (1) | (1) | (1) |
| body | Thickness | | [μm] | 120 | 140 | 100 | 100 | 100 |
| substrate | Apparent Density | | [g/cm³] | 0.40 | 0.40 | 0.40 | 0.40 | 0.40 |
| | Interlaminar strength | | [N/cm] | 17.5 | 19.1 | 12.6 | 12.6 | 12.6 |
| | 25% compressive strength | | [kPa] | 116 | 130 | 103 | 103 | 103 |
| | Tensile | Flow direction | [N/cm³] | 1023 | 994 | 1084 | 1084 | 1084 |
| | strength | Width direction | [N/cm³] | 740 | 713 | 790 | 790 | 790 |
| | Tensile | Flow direction | % | 518 | 535 | 508 | 508 | 508 |
| | elongation | Width direction | % | 284 | 344 | 224 | 224 | 224 |
| | Average | Thickness direction | [μm] | 26 | 33 | 20 | 20 | 20 |
| | bubble | Flow direction | [μm] | 137 | 147 | 126 | 126 | 126 |
| | diameter | Width direction | [μm] | 158 | 174 | 143 | 143 | 143 |

| Resin | Types | | α | α | α | α | α |
|---|---|---|---|---|---|---|---|
| film | Thickness of resin film | [μm] | 6 | 6 | 3 | 16 | 6 |
| | Thickness of adhesive layer | [μm] | 4 | 4 | 4 | 4 | 4 |
| Pressure- | Types | | 140 | A | A | A | B |
| sensitive | Gel fraction | [% by mass] | 42.5 | 42.5 | 42.5 | 42.5 | 37 |
| adhesive | Thickness | [μm] | 30 | 20 | 43 | 30 | 15 |
| layer | 180° peeling adhesive force | [N/20 mm] | 12.0 | 12.0 | 12.0 | 12.0 | 13.7 |

| | | | | | | |
|---|---|---|---|---|---|---|
| Total thickness | [μm] | 200 | 200 | 200 | 200 | 150 |
| Easy disassembly | | EXCELLENT | EXCELLENT | EXCELLENT | EXCELLENT | EXCELLENT |
| Peeling properties | Adherend A | EXCELLENT | EXCELLENT | GOOD | EXCELLENT | EXCELLENT |
| | Adherend B | EXCELLENT | EXCELLENT | GOOD | EXCELLENT | EXCELLENT |

| | | | | | |
|---|---|---|---|---|---|
| Impact resistance | GOOD | GOOD | GOOD | GOOD | GOOD |

TABLE 3

| | | | | Comparative | Comparative | Comparative | Comparative | Comparative |
|---|---|---|---|---|---|---|---|---|
| | | | | Example 1 | Example 2 | Example 3 | Example 4 | Example 5 |
| Foaming | Types | | | (1) | (6) | (1) | (4) | (1) |
| body | Thickness | | [μm] | 100 | 100 | 100 | 140 | 100 |
| substrate | Apparent Density | | [g/cm³] | 0.40 | 0.50 | 0.40 | 0.40 | 0.40 |
| | Interlaminar strength | | [N/cm] | 12.6 | 13.6 | 12.6 | 19.1 | 12.6 |
| | 25% compressive strength | | [kPa] | 103 | 270 | 103 | 130 | 103 |
| | Tensile | Flow direction | [N/cm³] | 1084 | 1456 | 1084 | 994 | 1084 |
| | strength | Width direction | [N/cm³] | 790 | 956 | 790 | 713 | 790 |
| | Tensile | Flow direction | % | 508 | 656 | 508 | 535 | 508 |
| | elongation | Width direction | % | 224 | 304 | 224 | 344 | 224 |
| | Average | Thickness direction | [μm] | 20 | 31 | 20 | 33 | 20 |
| | bubble | Flow direction | [μm] | 126 | 94 | 126 | 147 | 126 |
| | diameter | Width direction | [μm] | 143 | 369 | 143 | 174 | 143 |

| Resin | Types | | α | α | α | α | — |
|---|---|---|---|---|---|---|---|
| film | Thickness of resin film | [μm] | 6 | 6 | 6 | 6 | — |
| | Thickness of adhesive layer | [μm] | 4 | 4 | 4 | 4 | — |
| Pressure- | Types | | A | A | C | D | A |
| sensitive | Gel fraction | [% by mass] | 42.5 | 42.5 | 38 | 48 | 42.5 |
| adhesive | Thickness (foaming body substrate) | [μm] | 15 | 15 | 15 | 30 | 25 |
| layer | Thickness (resin film) | [μm] | 25 | 25 | 25 | 25 | 25 |
| | 180° peeling adhesive force | [N/20 mm] | 12.0 | 12.0 | 8.9 | 8.9 | 12.0 |

| Total thickness | [μm] | 150 | 150 | 150 | 200 | 150 |
|---|---|---|---|---|---|---|
| Easy disassembly | | EXCELLENT | POOR | POOR | POOR | EXCELLENT |
| Peeling properties | Adherend A | EXCELLENT | EXCELLENT | EXCELLENT | EXCELLENT | POOR |
| | Adherend B | POOR | POOR | POOR | POOR | POOR |

| | | | | | |
|---|---|---|---|---|---|
| Impact resistance | GOOD | GOOD | GOOD | GOOD | GOOD |

### REFERENCE SIGNS LIST

1 Double-sided pressure-sensitive adhesive tape
2 Acrylic plate
3 ABS plate
4 U-shaped measuring table
5 Impact base

1. A double-sided pressure-sensitive adhesive tape comprising:
resin films laminated on both surfaces of a foaming body substrate; and
pressure-sensitive adhesive layers laminated on the surface of the respective resin films,
wherein the foaming body substrate is a foaming body substrate having a density of 0.45 g/cm³ or less and an interlaminar strength of 10 N/cm or more, and the pressure-sensitive adhesive layer is a pressure-sensitive adhesive layer which exhibits a 180° peeling adhesive force 10 N/20 mm or more, when a pressure-sensitive adhesive tape obtained by providing the pressure-sensitive adhesive layer on a polyethylene terephthalate substrate having a thickness of 25 μm such that the thickness of the pressure-sensitive adhesive layer is 25 μm is rolled reciprocatively once on an aluminum plate with a 2 kg roller under the environment of a temperature of 23° C. and a relative humidity of 65% RH such that the pressure-sensitive adhesive tape adheres to the aluminum plate with pressure, is left to stand for one hour under the environment of a temperature of 23° C. and a relative humidity of 50% RH, and is then peeled at a peeling rate of 300 mm/min.

2. The double-sided pressure-sensitive adhesive tape according to claim 1,
which has a total thickness of 300 μm or less.

3. The double-sided pressure-sensitive adhesive tape according to claim 1,
wherein a tensile strength of the foaming body substrate is in a range of 500 N/cm² to 1,300 N/cm².

4. The double-sided pressure-sensitive adhesive tape according to claim 1,
wherein the resin film is a film obtained by using a polyester resin.

5. The double-sided pressure-sensitive adhesive tape according to claim 1,
wherein the foaming body substrate and the resin film are laminated with each other via an adhesive layer.

6. The double-sided pressure-sensitive adhesive tape according to claim 5,
wherein the adhesive layer is a layer containing a urethane resin.

7. The double-sided pressure-sensitive adhesive tape according to claim 1, which is used to perform fixing between components of an electronic device.

8. An electronic device having a configuration in which two or more components adhere to each other through the double-sided pressure-sensitive adhesive tape according to claim 7.
